(19) United States
(12) Patent Application Publication
(10) Pub. No.: US 2024/0355148 A1
(43) Pub. Date: Oct. 24, 2024

(54) LIGHT EMITTER ARRAY AND BEAM SHAPING ELEMENTS FOR EYE TRACKING WITH USER AUTHENTICATION AND LIVENESS DETECTION

(71) Applicant: Meta Platforms Technologies, LLC, Menlo Park, CA (US)

(72) Inventors: Mantas ZURAUSKAS, Redmond, WA (US); James SCHLOSS, Lake Stevens, WA (US); Pavel TROCHTCHANOVITCH, Shoreline, WA (US)

(73) Assignee: Meta Platforms Technologies, LLC, Menlo Park, CA (US)

(21) Appl. No.: 18/622,183

(22) Filed: Mar. 29, 2024

Related U.S. Application Data
(60) Provisional application No. 63/604,000, filed on Nov. 29, 2023.
(60) Provisional application No. 63/497,116, filed on Apr. 19, 2023.

(51) Int. Cl. G06V 40/40; G02B 27/42; G06F 3/01; G06T 19/00; G06V 10/143; G06V 40/10

(52) U.S. Cl. CPC G06V 40/40; G02B 27/4205; G06F 3/013; G06T 19/006; G06V 10/143; G06V 40/15

(57) ABSTRACT

Methods, systems, and apparatuses for eye tracking in a near-eye display device are described. In one aspect, an eye tracking system has an array of Vertical Cavity Surface-Emitting Lasers (VCSELs) with different groupings of VCSELs within the array providing structured light with different polarization states such that the structured light projected onto the user's eye has (i) a spatially varying and/or temporally-varying intensity profile and/or (ii) a spatially varying and/or temporally-varying polarization profile. In another aspect, an eye tracking system includes a light source, an image sensor, and a controller which controls the image sensor to capture series of images of light reflections from the eye when the eye is stationary, determines blood flow characteristics using pattern changes in the captured series of images, and performs user authentication and/or liveness detection based on the detected blood flow characteristics.

### CROSS-REFERENCE TO OTHER APPLICATIONS

This application claims priority to U.S. Prov. Pat. App. Ser. No. 63/497,116, entitled SPECKLE CONTRAST MEASUREMENTS FOR USER AUTHENTICATION AND LIVENESS DETECTION and filed on Apr. 19, 2023, and U.S. Prov. Pat. App. Ser. No. 63/604,000, entitled ARRAY OF LIGHT EMITTERS WITH BEAM SHAPING ELEMENT FOR EYE TRACKING SYSTEMS and filed on Nov. 29, 2023, the entire contents of both of which are incorporated herein by reference.

### TECHNICAL FIELD

This patent application relates generally to user authentication, and more specifically, to biometric user authentication and liveness detection in a near-eye display device.

This patent application relates generally to eye tracking in augmented and/or virtual reality (AR/VR) devices, and in particular, to projecting light with spatially varying intensity and polarization profiles for eye tracking.

### BACKGROUND

With recent advances in technology, the prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms of wearable display systems. One such example may be a head-mounted display (HMD) device, such as a wearable eyewear, a wearable headset, or eyeglasses. In some examples, the head-mounted display (HMD) device may project or direct light to may display virtual objects or combine images of real objects with virtual objects, as in virtual reality (VR), augmented reality (AR), or mixed reality (MR) applications. For example, in an augmented reality (AR) system, a user may view both images of virtual objects (e.g., computer-generated images (CGIs)) and the surrounding environment. Head-mounted display (HMD) devices may also present interactive content, where a user's (wearer's) gaze may be used as input for the interactive content.

Corresponding with the increasing use of wearable devices, such as virtual reality (VR), augmented reality (AR), and/or mixed reality (MR) glasses, there may be an increasing need for such devices to have privacy protection and anti-spoofing measures, such as user identification and authentication, as well as liveness detection, i.e., detecting whether a live user is indeed present.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display, according to an example.

FIGS. 2A-2C illustrate various views of a near-eye display device in the form of a head-mounted display (HMD) device, according to examples.

FIG. 3 illustrates a perspective view of a near-eye display device in the form of a pair of glasses, according to an example.

FIGS. 4A and 4B illustrate light projection portions of an eye tracking system, according to examples.

FIG. 5 illustrates a vertical-cavity surface-emitting laser (VCSEL) array capable of projecting arbitrary patterns of structured light with varying polarization states, according to an example.

FIG. 6A illustrates a light projection system which allows for shifting intensity patterns, according to an example.

FIGS. 6B and 6C illustrate a light projection system which allows for both intensity and polarization state modulation, according to an example.

FIGS. 6D and 6E illustrate a light projection system which allows for phase shifting as well as both intensity and polarization state modulation, according to an example.

FIG. 7 illustrates a top view of a near-eye display device in the form of a pair of glasses which may be used for user authentication and/or liveness detection, according to an example.

FIG. 8A illustrates a top view of a near-eye display device in the form of a pair of glasses having multispectral illumination sources, which may be used for user authentication and/or liveness detection, according to an example.

FIG. 8B illustrates a schematic block diagram of a near-eye display device having multispectral illumination sources, which may be used for user authentication and liveness detection, according to an example.

FIG. 8C is a graph of the molar extinction coefficient vs. wavelength of oxygenated and non-oxygenated hemoglobin, which characteristics may be used for user authentication and/or liveness detection by the near-eye display devices in FIGS. 8A and 8B, according to an example.

FIG. 9A illustrates a top view of a near-eye display device in the form of a pair of glasses having a waveguide in which illumination source(s) may be disposed, which may be used for user authentication and/or liveness detection, according to an example.

FIG. 9B illustrates a schematic block diagram of a near-eye display device having a waveguide in which illumination source(s) may be disposed, which may be used for user authentication and/or liveness detection, according to an example.

FIG. 10 illustrates a top view of a near-eye display device in the form of a pair of glasses having a retinal projection system (RPS), which may be used for user authentication and/or liveness detection, according to an example.

FIG. 11 illustrates a flow diagram for a user authentication and/or liveness detection method using a near-eye display device, according to some examples.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

As used herein, a “near-eye display device” may refer to any display device (e.g., an optical device) that may be in close proximity to a user's eye. Accordingly, a near-eye display device may be a head-mounted display (HMD) device, such as a wearable eyewear, a wearable headset, and/or “smartglasses,” which may be used for interacting with virtual reality (VR), augmented reality (AR), and/or mixed reality (MR) environments, or any environment of real and virtual elements, such as a “metaverse.” As used herein, a “wearable device” may refer to any portable electronic device that may be worn on any body part of a user and used to present audio and/or video content, control other devices, monitor bodily functions, and perform similar actions. As used herein, a “user” may refer to a user or wearer of a “near-eye display device” and/or a “wearable display.”

Methods, systems, and apparatuses for eye tracking in a near-eye display device are described herein.

In one aspect, an eye tracking system has an array of Vertical Cavity Surface-Emitting Lasers (VCSELs) with different groupings of VCSELs within the array providing structured light with different polarization states. Accordingly, the structured light projected onto the user's eye has (i) a spatially varying and/or temporally-varying intensity profile and/or (ii) a spatially varying and/or temporally-varying polarization profile.

In another aspect, an eye tracking system includes a light source, an image sensor, and a controller which controls the image sensor to capture series of images of light reflections from the eye when the eye is stationary. The controller determines blood flow characteristics using pattern changes in the captured series of images, and performs user authentication and/or liveness detection based on the detected blood flow characteristics.

### Light Projection Systems for Structured Light Patterns

For projecting structured light patterns in eye tracking systems, light source arrays provide an opportunity for static or dynamic light shaping. If a micro-array of illuminators is used, there is an opportunity to provide diversity of properties at the individual emitter level, without significant increase in manufacturing process complexity. Introducing diversity unlocks more robust operation or functionalities such as dynamic phase shifting in fringe or structured polarization projection systems.

In some examples of the present disclosure, systems, methods, and devices for projecting light with spatially varying intensity and polarization profiles are provided. Example configurations permit static projection of illumination patterns. Further, dynamically switchable vertical-cavity surface-emitting laser (VCSEL) or micro-LED arrays may be used for dynamic pattern generation. The VCSEL array may project arbitrary patterns by using polarization-locked light sources arranged in lines and switched on in sequence. The VCSELs may also be configured as a cluster having different polarization states. One or more optical elements to adjust polarization and/or spatial profiles may be combined with the VCSEL array.

User Authentication and/or Liveness Detection

As mentioned above, privacy protection and anti-spoofing measures, such as user identification and liveness detection, are important for ensuring secure access to wearable devices, such as virtual reality (VR), augmented reality (AR), and/or mixed reality (MR) glasses. Typical imaging-based authentication approaches may be attacked using, for example, videos, images, or three-dimensional phantoms designed to replicate the eye of a user.

According to examples of the present disclosure, systems, devices, and/or methods for user authentication and/or liveness detection in a near-eye display device are presented. In some examples, speckle contrast imaging is used to record temporal changes caused by the blood flow in the capillaries in the sclera of, and the skin around, the user's eye. Such capillary patterns are unique to each individual, and thus may be used to identify and authenticate the user, as well as confirm the user is alive. In some examples, an eye tracking system of the near-eye display device may perform the speckle contrast imaging at moments when the user's eye is stationary (i.e., when the eye of the user is still or otherwise motionless). In some examples, multi-spectral illumination may be used to isolate and capture different unique features, characteristics, measurements, etc., of the user's eye and contiguous skin tissue for purposes of user authentication and/or liveness detection. In some examples, a retinal projection system may be employed to isolate and capture unique features, characteristics, measurements, etc., of the retina of the user's eye for purposes of user authentication and/or liveness detection.

While some advantages and benefits of the present disclosure are apparent, other advantages and benefits may include increased accuracy, additional functionalities, and reduced complexity without increasing manufacturing complexity of eye tracking sub-systems in near-eye display systems.

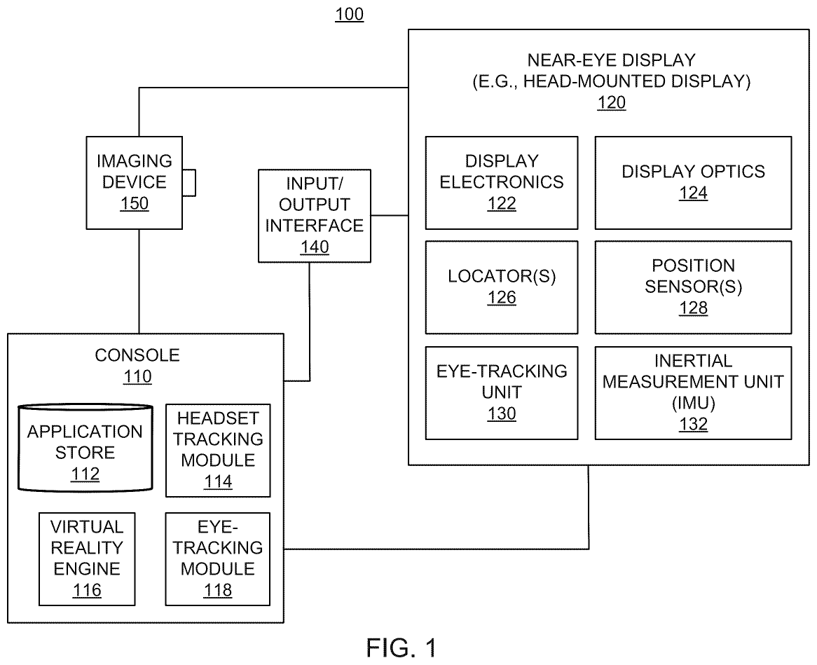

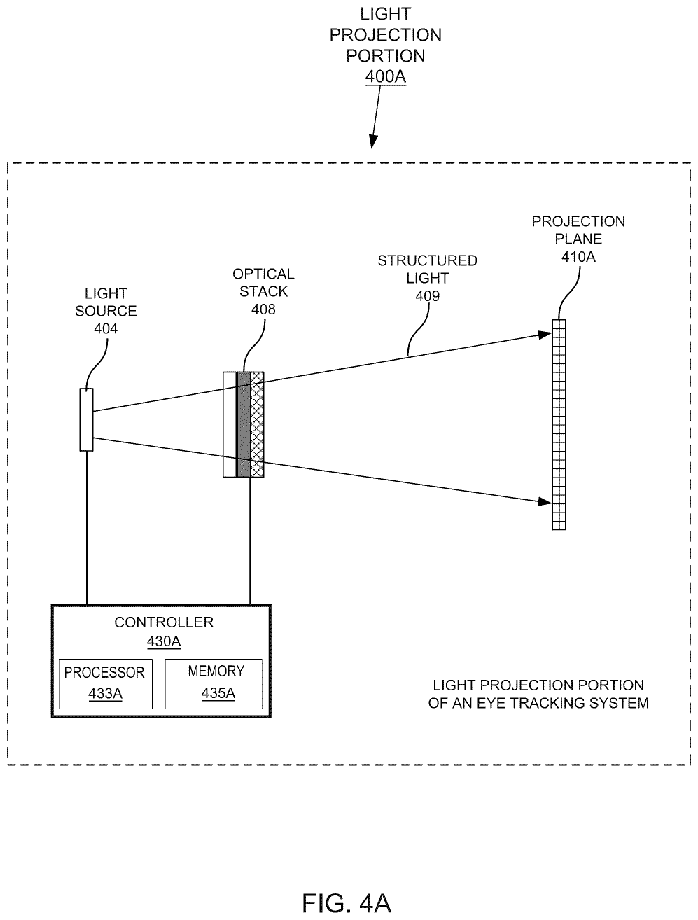

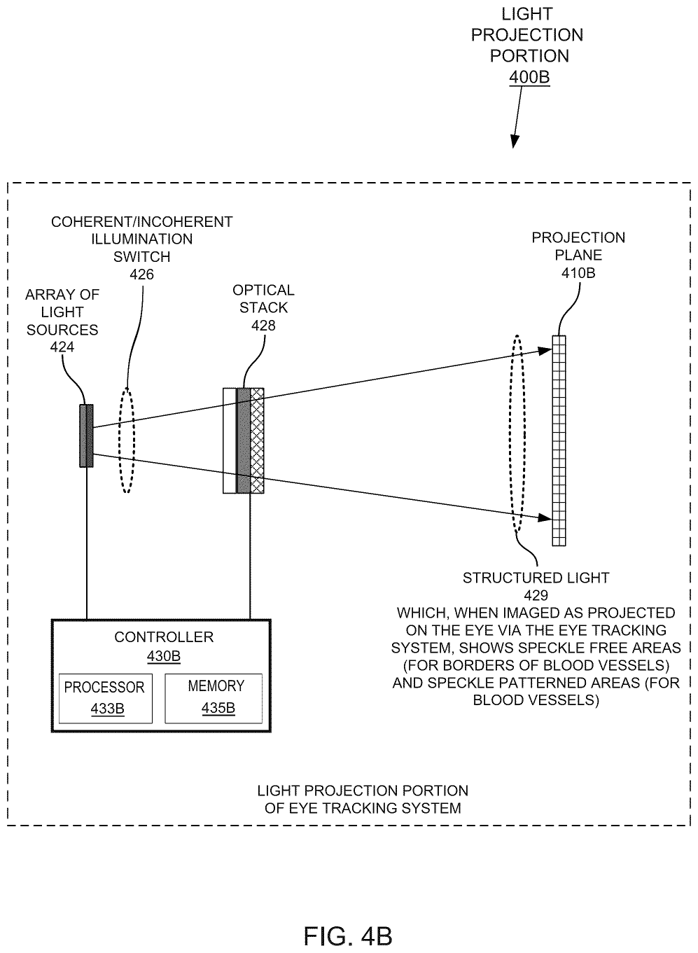

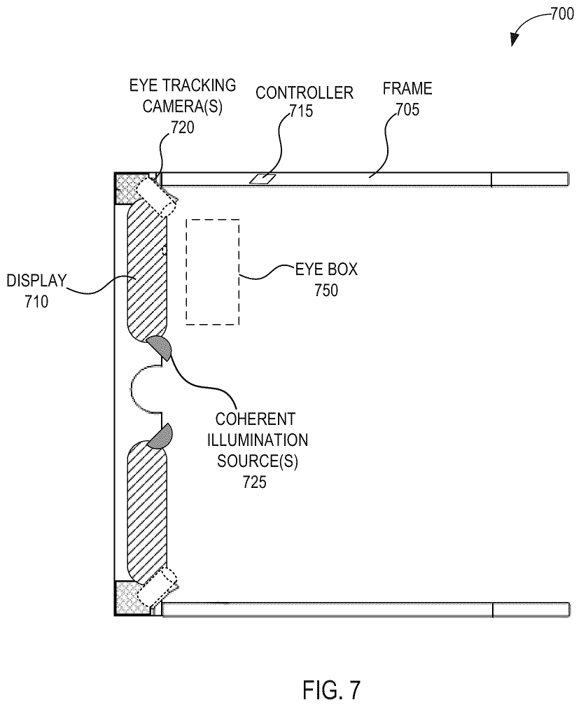

The following disclosure is broken down into 3 main sections:
I. Near-Eye Display Device(s), describing near-eye display devices which may be employed with examples of the present disclosure, with reference to FIGS. 1-3;
II. Structured Light Projection with Static and/or Dynamic Light Shaping, describing light projection systems for beam-shaping, intensity/polarization state modulation, and phase shifting for eye tracking systems with reference to FIGS. 4A-6E; and
III. User Authentication & Liveness Detection, describing eye tracking systems which may be used to perform user authentication and liveness detection with reference to FIGS. 7-11.

### I. Near-Eye Display Device(s)

FIG. 1 illustrates a block diagram of an artificial reality system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein a “user” may refer to a user or wearer of a “near-eye display.”

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eye box, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular head-mounted display (HMD)) or both eyes (for binocular head-mounted displays (HMDs)). Also, as used herein, an “eye box” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eye box.

In some examples, the near-eye display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

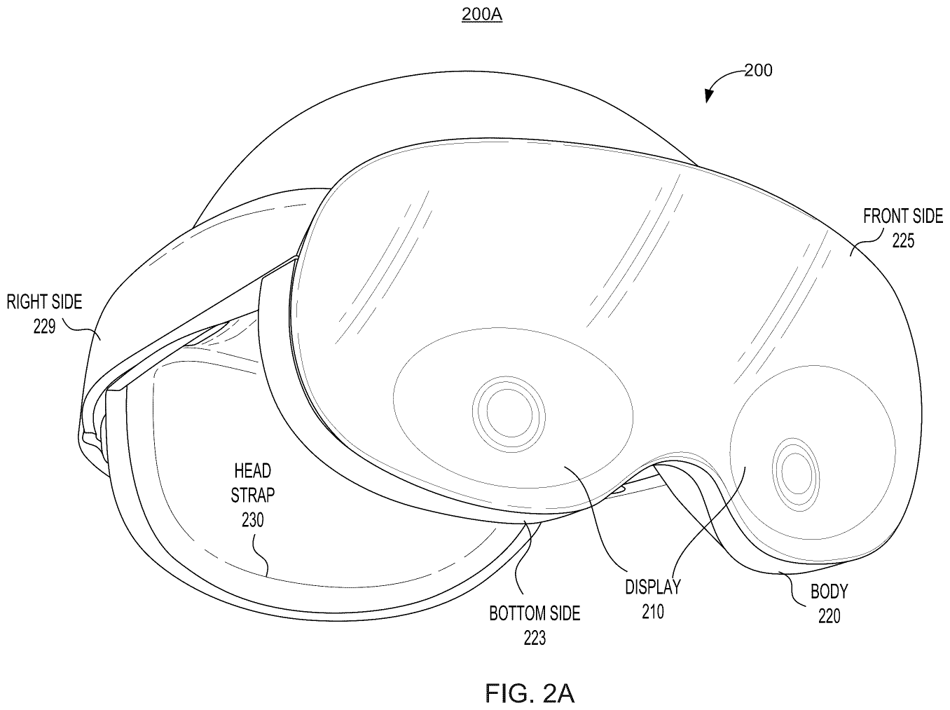

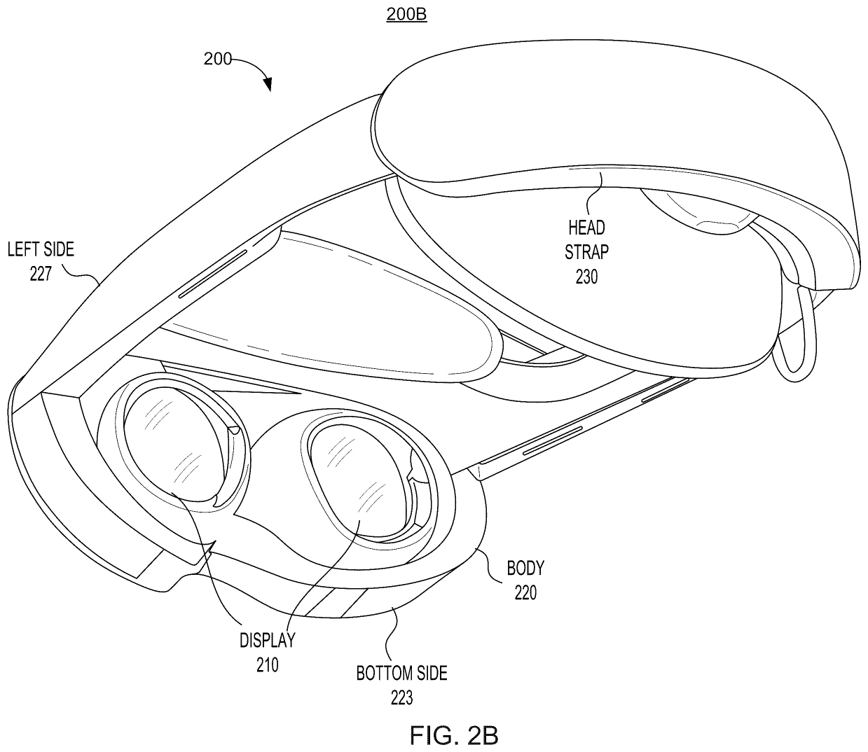

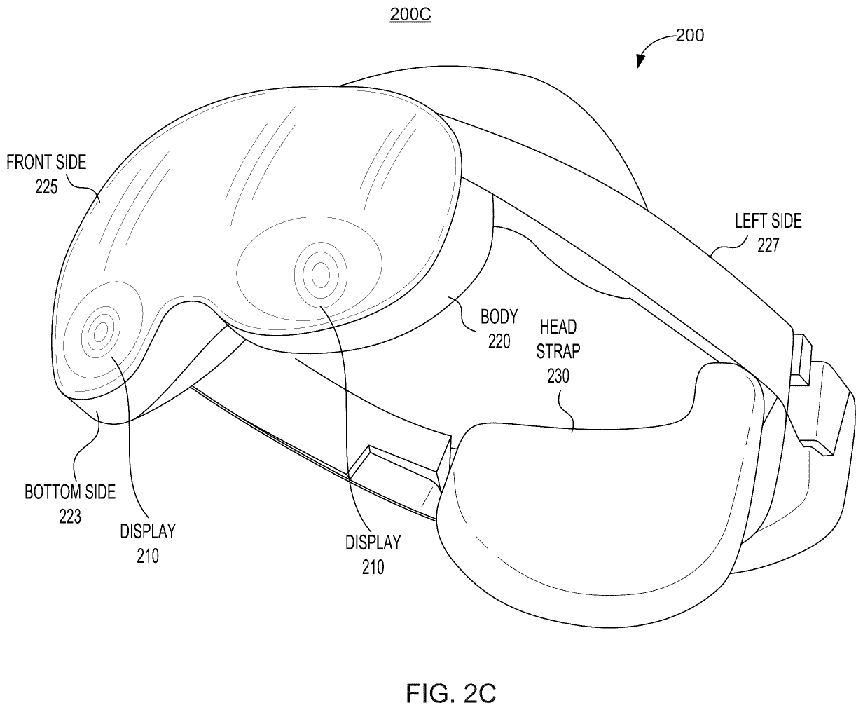

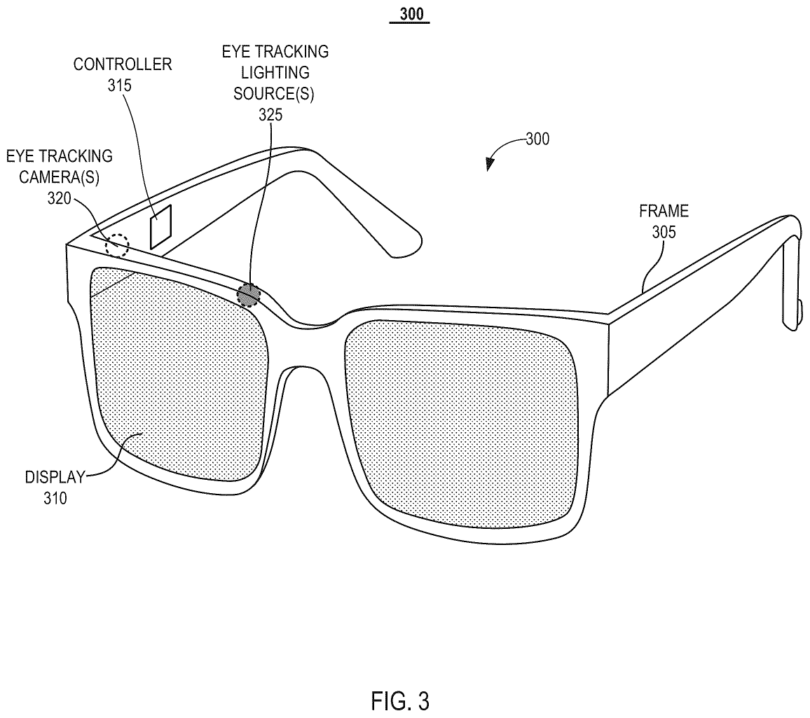

In some examples, the near-eye display 120 may be implemented in any suitable form-factor, including a head-mounted display (HMD), a pair of glasses, or other similar wearable eyewear or device. Examples of the near-eye display 120 are further described below with respect to FIGS. 2 and 3. Additionally, in some examples, the functionality described herein may be used in a head-mounted display (HMD) or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye tracking unit 130. In some examples, the near-eye display 120 may also include one or more locators 126, one or more position sensors 128, and an inertial measurement unit (IMU) 132. In some examples, the near-eye display 120 may omit any of the eye tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the near-eye display 120 may include a projector (not shown in FIG. 1), which may form an image in angular domain for direct observation by a viewer's eye through a pupil. The projector may employ a controllable light source (e.g., a laser source) and a micro-electromechanical system (MEMS) beam scanner to create a light field from, for example, a collimated light beam. In some examples, the same projector or a different projector may be used to project a fringe pattern on the eye, which may be captured by a camera and analyzed (e.g., by the eye tracking unit 130) to determine a position of the eye (the pupil), a gaze, etc.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube reflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

The eye tracking unit 130 may include one or more eye tracking systems. As used herein, “eye tracking” may refer to determining an eye's position or relative position, including orientation, location, and/or gaze of a user's eye. In some examples, an eye tracking system may include an imaging system that captures one or more images of an eye and may optionally include a light emitter, which may generate light (e.g., a fringe pattern) that is directed to an eye such that light reflected by the eye may be captured by the imaging system (e.g., a camera). In other examples, the eye tracking unit 130 may capture reflected radio waves emitted by a miniature radar unit. These data associated with the eye may be used to determine or predict eye position, orientation, movement, location, and/or gaze.

In some examples, the near-eye display 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the optional console 110 may include an application store 112, a headset tracking module 114, a virtual reality engine 116, and an eye tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye tracking module 118. Based on the received information, the virtual reality engine 116 may determine content to provide to the near-eye display 120 for presentation to the user.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

As mentioned herein, one or more light source arrays may be used to project structured light patterns allowing static or dynamic light shaping. With micro-array of illuminators diversity of properties may be provided at the individual emitter level. As a result, operation or functionality options may be pursued such as dynamic phase shifting in fringe or structured polarization projection systems. An eye tracking system according to examples may project light with spatially varying intensity and polarization profiles. Furthermore, dynamically switchable VCSEL or micro-LED arrays may be used for dynamic pattern generation.

FIGS. 2A-2C illustrate various views of a near-eye display device in the form of a head-mounted display (HMD) device 200, according to examples. In some examples, the head-mounted device (HMD) device 200 may be a part of a virtual reality (VR) system, an augmented reality (AR) system, a mixed reality (MR) system, another system that uses displays or wearables, or any combination thereof. As shown in diagram 200A of FIG. 2A, the head-mounted display (HMD) device 200 may include a body 220 and a head strap 230. The front perspective view of the head-mounted display (HMD) device 200 further shows a bottom side 223, a front side 225, and a right side 229 of the body 220. In some examples, the head strap 230 may have an adjustable or extendible length. In particular, in some examples, there may be a sufficient space between the body 220 and the head strap 230 of the head-mounted display (HMD) device 200 for allowing a user to mount the head-mounted display (HMD) device 200 onto the user's head. For example, the length of the head strap 230 may be adjustable to accommodate a range of user head sizes. In some examples, the head-mounted display (HMD) device 200 may include additional, fewer, and/or different components such as a display 210 to present a wearer augmented reality (AR)/virtual reality (VR) content and a camera to capture images or videos of the wearer's environment.

As shown in the bottom perspective view of diagram 200B of FIG. 2B, the display 210 may include one or more display assemblies and present, to a user (wearer), media or other digital content including virtual and/or augmented views of a physical, real-world environment with computer-generated elements. Examples of the media or digital content presented by the head-mounted display (HMD) device 200 may include images (e.g., two-dimensional (2D) or three-dimensional (3D) images), videos (e.g., 2D or 3D videos), audio, or any combination thereof. In some examples, the user may interact with the presented images or videos through eye tracking sensors enclosed in the body 220 of the head-mounted display (HMD) device 200. The eye tracking sensors may also be used to adjust and improve quality of the presented content.

In some examples, the head-mounted display (HMD) device 200 may include various sensors (not shown), such as depth sensors, motion sensors, position sensors, and/or eye tracking sensors. Some of these sensors may use any number of structured or unstructured light patterns for sensing purposes. In some examples, the head-mounted display (HMD) device 200 may include an input/output interface for communicating with a console communicatively coupled to the head-mounted display (HMD) device 200 through wired or wireless means. In some examples, the head-mounted display (HMD) device 200 may include a virtual reality engine (not shown) that may execute applications within the head-mounted display (HMD) device 200 and receive depth information, position information, acceleration information, velocity information, predicted future positions, or any combination thereof of the head-mounted display (HMD) device 200 from the various sensors.

In some examples, the information received by the virtual reality engine may be used for producing a signal (e.g., display instructions) to the display 210. In some examples, the head-mounted display (HMD) device 200 may include locators (not shown), which may be located in fixed positions on the body 220 of the head-mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped like eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

In some examples, the eye tracking system may project light with spatially varying intensity and polarization profiles. Furthermore, dynamically switchable VCSEL or micro-LED arrays may be used for dynamic pattern generation.

FIG. 3 is a perspective view 300 of a near-eye display device 300 in the form of a pair of glasses (or other similar eyewear) which may be used in accordance with examples of the present disclosure. In some examples, the near-eye display device 300 may be a specific example of near-eye display 120 of FIG. 1 and may be configured to operate as an augmented reality (AR) display and/or a mixed reality (MR) display.

In some examples, the near-eye display device 300 may include a frame 305 and a display 310. In some examples, the display 310 may present media or other content to a user. In some examples, the display 310 may include display electronics and/or display optics, similar to components described with respect to FIGS. 1 and 2A-2C. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc. In some examples, the display 310 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

In some examples, the near-eye display device 300 may include an eye tracking system, which may include an eye tracking lighting source(s) 325, and an eye tracking camera(s) 320 or other image sensor facing inwards towards the user, and a controller 315. In FIG. 3, the eye tracking system of the near-eye display device 300 constitutes the eye tracking lighting source(s) 325 and the camera(s) 320, although examples of the present disclosure are not so limited—i.e., the eye tracking lighting source(s) 325 and the eye tracking camera(s) 320 or other image sensor according to the present disclosure may be separate from the eye tracking system of the near-eye display device 300. Similarly, in some examples, the controller 315 may control the camera(s) 320 and may or may not control the eye tracking lighting source(s) 325. Although only the relevant components around and directed to the user's right eye are labelled in FIG. 3, substantially identical components may be similarly directed to the user's left eye in the near-eye display device 300, as would be understood by one of ordinary skill in the art.

In some examples, the controller 315 may perform eye tracking by calculating/determining the eye's position or relative position, which may include the orientation, location, and/or gaze of the user's eye. In some examples, the controller 315 may be communicatively connected with a memory, which may be at least one non-transitory computer-readable storage medium storing instructions executable by the controller 315. The controller 315 may include multiple processing units, and those multiple processing units may further execute instructions in parallel. The at least one non-transitory computer-readable storage medium may be any memory, such as a hard disk drive, a removable memory, or a solid-state drive (e.g., flash memory or dynamic random access memory (DRAM)). In various examples, the controller 315 may be further subdivided into multiple devices (for example, the functions of the controller 315 may be separated among various components, such as a digital signal processing (DSP) chip for eye tracking analysis as well as a Central Processing Unit (CPU) for controlling, e.g., the eye tracking lighting source(s) 325). In some examples, the controller 315 may not be disposed on or within the glasses portion of the near-eye display device 300 as shown in FIG. 3, but instead may be separate from the glasses portion of the near-eye display device 300. In such examples, the controller 315 may be disposed in a separate control module or a console/control hand device connected by wire and/or wirelessly with the glasses portion of the near-eye display device 300.

In some examples, the eye tracking lighting source(s) 325 may be a vertical-cavity surface-emitting laser (VCSEL) diode. In other examples, the eye tracking lighting source(s) 325 may be almost any light and/or radiation source, as would be understood by one of ordinary skill in the art, such as, e.g., a laser, a light emitting diode (LED), a side-emitting laser diode, a superluminescent light-emitting diode (SLED), and/or an array or multitude of any of the same. In some examples, the eye tracking lighting source(s) 325 may project light/radiation in the ultraviolet spectrum (e.g., about 200-350 nm), the visual light spectrum (e.g., about 350 nm-750 nm), the infrared spectrum (e.g., about 750 nm-1000 nm), and/or any electromagnetic radiation spectrum. In some examples, to perform eye tracking, the eye tracking lighting source(s) 325 may project a pattern upon the user's eye. As would be understood by one of ordinary skill in the art, any of a large variety of eye tracking techniques may be employed, depending upon, for example, the light sources used, the image sensors used, the processing capabilities of the near-eye display device, the form factor of the near-eye display device, etc.

In some examples, the near-eye display 300 may further include various sensors on or within a frame 305. In some examples, the various sensors may include any number of depth sensors, motion sensors, position sensors, inertial sensors, and/or ambient light sensors, as shown. In some examples, the various sensors may include any number of image sensors configured to generate image data representing different fields of views in one or more different directions. In some examples, the various sensors may be used as input devices to control or influence the displayed content of the near-eye display, and/or to provide an interactive virtual reality (VR), augmented reality (AR), and/or mixed reality (MR) experience to a user of the near-eye display 300. In some examples, the various sensors may also be used for stereoscopic imaging or other similar applications.

In some examples, one or more processors may be employed in any near-eye display device 100 (such as, e.g., the head-mounted display (HMD) device 200 in FIGS. 2A-2C and/or the near-eye display device 300 in the form of a pair of glasses in FIG. 3) to perform any of the methods, functions, and/or processes described herein by executing instructions contained on a non-transitory computer-readable storage medium. These one or more processors (such as, e.g., the controller 315 of the near-eye display device 300 in the form of glasses in FIG. 3), may be, or may include, one or more programmable general-purpose or special-purpose single—and/or multi-chip processors, a single—and/or multi-core processors, microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices. In some examples, the non-transitory computer-readable storage medium (such as, e.g., the application store 112 of the near-eye display device 120 in FIG. 1) may include read-only memory (ROM), flash memory, and/or random access memory (RAM)—any of which may be the main memory into which an operating system, various application programs, and/or a Basic Input-Output system (BIOS) which controls basic hardware operation such as the interaction with one or more peripheral components may be loaded/stored. Code or computer-readable instructions to implement the methods, functions, and/or operations discussed and/or described herein may be stored in any suitable computer-readable storage media and/or may be received via one or more communication/transmission interfaces, as would be understood by one of ordinary skill in the art.

II. Structured Light Projection With Static and/or Dynamic Light Shaping

In some examples, the light source employed for eye tracking may be an array configured to enable static or dynamic light shaping of projected structured light patterns. A vertical-cavity surface-emitting laser (VCSEL) array may project arbitrary patterns by using polarization-locked light sources arranged in lines and switched on in sequence. The VCSELs may also be configured as a cluster having different polarization states. One or more optical elements may be combined with the VCSEL array.

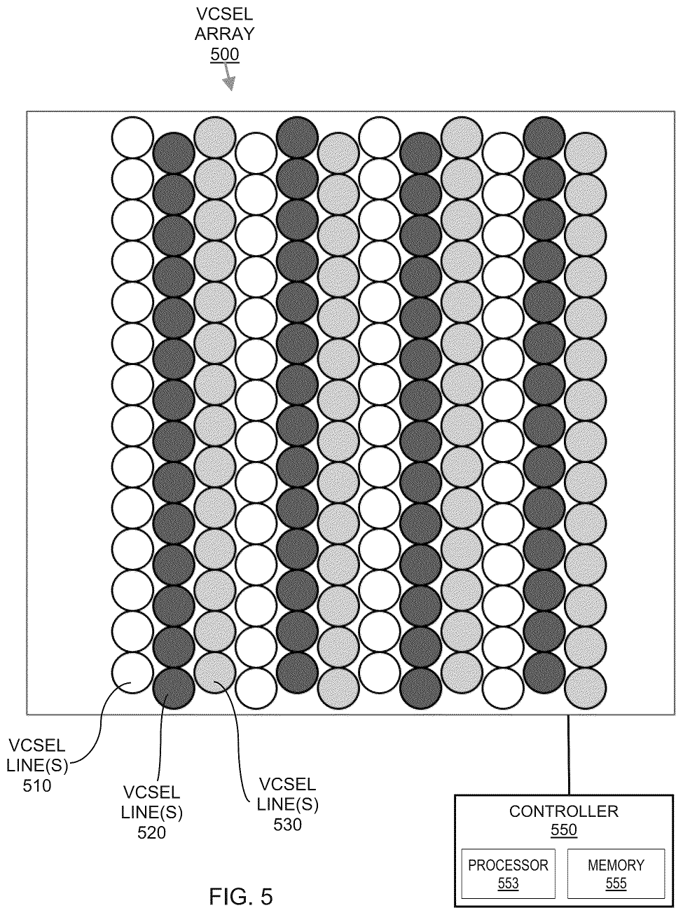

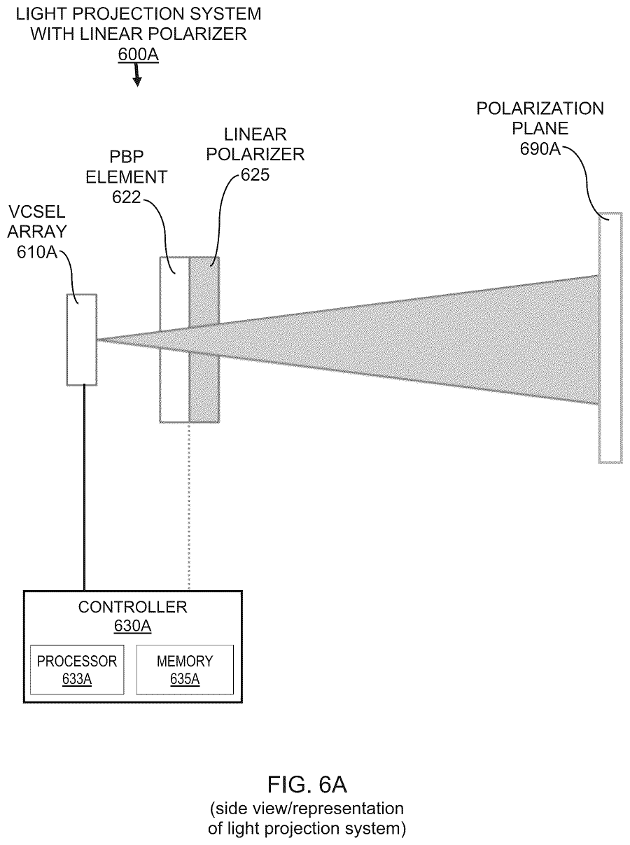

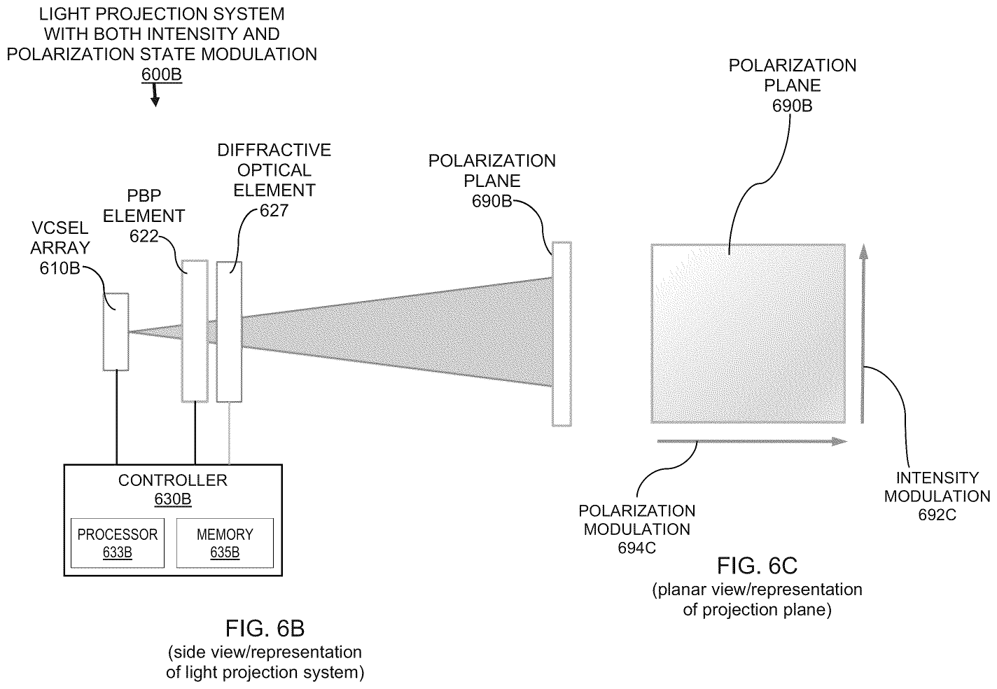

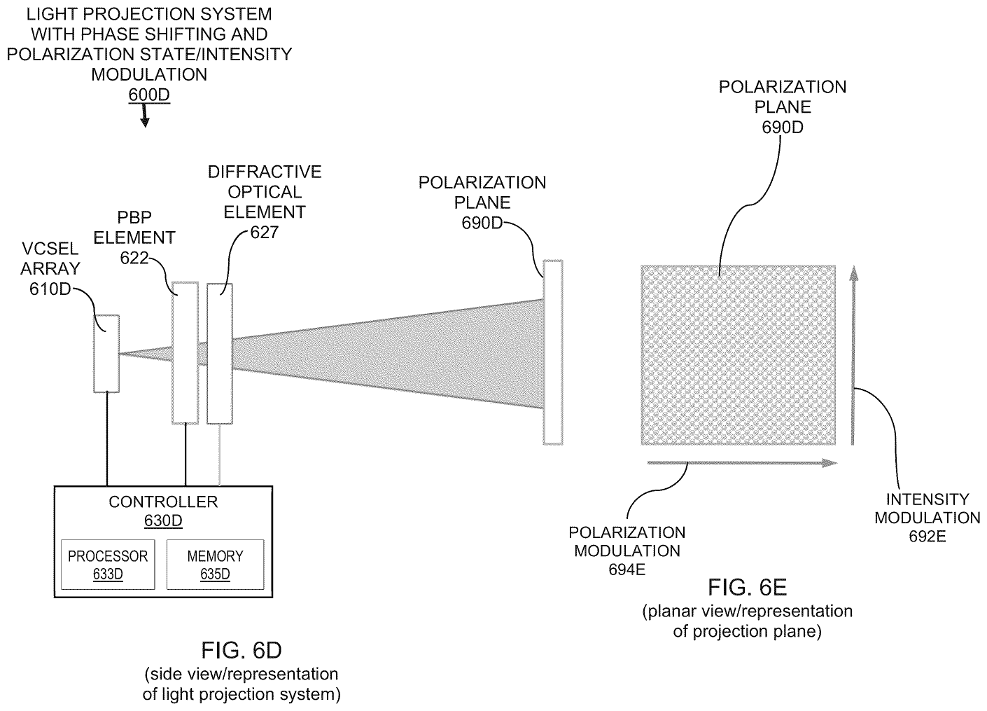

Below, generally speaking, examples of different light projection systems (for eye tracking) in accordance with the present disclosure are described with reference to FIGS. 4A and 4B; examples of different light source arrays in accordance with the present disclosure are described with reference to FIG. 5; and examples of different configurations in accordance with the present disclosure for projecting structured light with intensity and/or polarization profiles which may vary spatially or temporally are described with reference to FIGS. 6A-6E.

Broadly speaking, each of FIGS. 4A and 4B are representations illustrating the light projection portion of an eye tracking system (such as, e.g., any of the eye tracking systems discussed in reference to the Figures above), according to different examples. Accordingly, a projection plane 410A and 410B is shown in each of FIGS. 4A and 4B instead of showing the user's eye itself or an eye box (such as shown in, e.g., FIGS. 7, 8A, 9A, and 10 discussed below). As shown in both FIGS. 4A and 4B, structured light may be projected from one or more light sources, through an optical assembly/stack, onto the projection plane 410A/B, which represents the pattern created by the structured light which would be formed on the user's eye.

FIG. 4A illustrates a light projection portion 400A of an eye tracking system (such as, e.g., the eye tracking systems described in reference to FIGS. 1, 2A-2C, and 3 above, or the eye tracking systems in FIG. 7, 8A, 8B, 9A, 9B, or 10 discussed below), which may include a light source 404 and an optical assembly (optical stack) 408. As used herein, “optical stack” and “optical assembly” may be used interchangeably to refer to one or more optical elements, which may be active and/or inactive, static and/or dynamic, and may or may not shape, modulate, and/or otherwise process the light projected by the light source 404. In FIG. 4A, structured light 409 may be projected by the light source 404, through the optical assembly/stack 408, onto the projection plane 410A, which represents the pattern created by the structured light 409 which would be formed on the user's eye.

As shown in FIG. 4A, components of the light projection portion 400A of the eye tracking system may be operably and communicatively connected to, and/or controlled by, a controller 430A which may include, and/or may be communicatively connected to, a processor 433A and/or a memory 435A, which may be a non-transitory computer-readable storage medium. In some examples, the controller 430A may control and/or send/receive data and other signals from the light source 404 and the optical assembly (optical stack) 408, and may further process and/or perform functions upon any such received signals. In some examples, the processor 433A in the controller 430A may perform any of the methods, functions, and/or processes described herein by executing instructions contained on the memory 435A and/or another suitable non-transitory computer-readable storage medium. In some examples, the controller 430A may be one or more of the eye tracking unit 130 and/or eye tracking module 118 in FIG. 1 discussed above, the controller 315 in FIG. 3 discussed above, any of the controller(s) 630A/B/D, 715, 815, 816, 930, 931, and/or 1040 in FIGS. 6A/B/D, 7A, 8A, 8B, 9A, 9B, and/or 10, respectively, discussed below, and/or any other processing or controlling module which may be used in the near-eye display device, as would be understood by one of ordinary skill in the art.

FIG. 4B illustrates a light projection portion 400B of an eye tracking system (such as, e.g., the eye tracking systems described in reference to FIGS. 1, 2A-2C, and 3 above, or the eye tracking systems in FIG. 7, 8A, 8B, 9A, 9B, or 10 discussed below), which may include an array of light sources 424, a switch 426 which may switch the light projected by the array of light sources 424 between coherent and incoherent illumination, and an optical assembly (optical stack) 428 which receives the light from the switch 426 as input on one side and projects structured light 429 as output on the other side onto the projection plane 410B (representing the user's eye).

In FIG. 4B, similarly to FIG. 4A, components of the light projection portion 400B may be operably and communicatively connected to, and/or controlled by, a controller 430B which may include, and/or may be communicatively connected to, a processor 433B and/or a memory 435B, which may include a non-transitory computer-readable storage medium. In some examples, the controller 430B may control and/or send/receive data and other signals from the array of light sources 424 and one or more components within the optical assembly (optical stack) 428, and may further process and/or perform functions upon any such received signals. In some examples, the processor 433B in the controller 430B may perform any of the methods, functions, and/or processes described herein by executing instructions contained on the memory 435B and/or another suitable non-transitory computer-readable storage medium. In some examples, the controller 430B may be one or more of the eye tracking unit 130 and/or eye tracking module 118 in FIG. 1 discussed above, the controller 315 in FIG. 3 discussed above, any of the controller(s) 630A/B/D, 715, 815, 816, 930, 931, and/or 1040 in FIGS. 6A/B/D, 7A, 8A, 8B, 9A, 9B, and/or 10, respectively, discussed below, and/or any other processing or controlling module which may be used in the near-eye display device, as would be understood by one of ordinary skill in the art.

As shown in FIG. 4B, the array of light sources 424 may project light with different polarization or spatial profiles and the switch 426 may switch that projected light between coherent and incoherent illumination, thereby providing structured light 429 that may be employed for the detection/identification of blood vessels in the user's eye by the eye tracking system. Namely, because imaging or otherwise sensing (and processing by the eye tracking system) of the structured light 429 projected on the user's eye may result in speckle-free areas indicating the borders/outlines of the blood vessels and speckled areas indicating the blood vessels themselves.

In some examples, the array of light sources 424 may include an array of vertical-cavity surface-emitting lasers (VCSELs), such as described with reference to FIG. 5 below. In some examples, the array of light sources 424 may include an array of micro-LED or micro-OLED light sources, thereby providing the ability to switch between coherent and incoherent illumination and allowing for increased emission angles and, when and where suitable, speckle-free operation. In some examples, two or more emitters of high-quality laser and low-quality or LED (multimodal or broad optical BW) may be used as alternative light sources. By switching between the two sources/modes, speckle free image(s) identifying borders may be obtained and image(s) with speckle patterns identifying blood vessels may be obtained. This configuration may be combined with fringe and/or white field illumination.

In examples where the array of light sources 424 may include a VCSEL array, such as described with reference to FIG. 5 below, the VSCELs may have one or more of a wide variety of possible VCSEL constructions, architectures, and/or fabrications, as would be understood by one of ordinary skill in the art. In such examples, one or more of the VCSELs may include, for example, a VCSEL with multiple active regions (e.g., a bipolar cascade VCSEL); a tunnel junction VCSEL; a tunable VCSEL which may employ, e.g., a micro-electromechanical system (MEMS); a wafer-bonded and/or wafer-fused VCSEL; a Vertical External Cavity Surface Emitting Laser (VECSEL); a Vertical Cavity Semiconductor Optical Amplifier (VCSOA) which may be optimized as amplifiers as opposed to oscillators; two or more Vertical Cavity Surface Emitting Lasers (VCSELs) disposed on top of one another (i.e., vertically) such that each one pumps the one on top of it (e.g., monolithically optically pumped VCSELs); any other suitable VCSEL construction, architecture, and/or fabrication, as would be understood by one of ordinary skill in the art in light of the examples of the present disclosure. Moreover, as would be understood by one of ordinary skill in the art, dynamic control of the polarization states of a VCSEL array may be implemented by many different possible means-see, e.g., Koerner et al., “Polarization Multiplexing in VCSEL-Arrays,” Proceedings of the Society of Photo-Optical Instrumentation Engineers (SPIE) 12439, Vertical-Cavity Surface Emitting Lasers XXVII (15 Mar. 2023), (i.e., SPIE-Photonics-West 2023, San Francisco, CA), which is hereby incorporated by reference herein in its entirety.

In some examples, the array of light sources 424 may include metasurface-based light sources, where one or more of the individual metasurface-based light sources may have electrically-switchable polarization states. In such examples, fixed linear polarizers may not need to be employed in the optical stack 428. For a description of an example of such a type of light source which may be employed in accordance with the present disclosure, see, e.g., Xu et al., Metasurface Quantum-Cascade Laser with Electrically Switchable Polarization, Optica, Vol. 4, No. 5 (April 2017), which is hereby incorporated by reference herein in its entirety. In some examples, gratings and other surfaces or coatings may be employed to allow for controlling, modifying, or otherwise affecting the polarization state of the structured light. See, e.g., Ostermann & Riedl, “Polarization Control of VCSELS,” Annual Report 2003, Institute of Optoelectronics, Ulm University, pp. 35-40 (2003), which is hereby incorporated by reference herein in its entirety.

In some examples, the array of light sources 424 may include other light sources suitable in light of the present disclosure besides VCSELs, with appropriate modifications where suitable or necessary, such as, for example, light emitting diodes (LEDs) or micro-LEDs (mLEDs), side-emitting laser diodes, superluminescent light-emitting diodes (SLEDs), organic light emitting diodes (OLEDs), inorganic light emitting diodes (ILEDs), active-matrix organic light emitting diodes (AMOLEDs), transparent organic light emitting diode (TLEDs), edge-emitting lasers (EELs), horizontal cavity surface emitting lasers (HC-SELs), quantum dot lasers (QDLs), quantum cascade lasers (QCLs), and/or any other suitable light source or combination thereof.

In some examples, the optical stack 428 may include one or more filters, polarizers (such as the linear polarizer shown in FIG. 6A described below), diffractive optical elements (DOEs-such as shown in FIG. 6B described below), Pancharatnam-Berry Phase (PBP) elements (such as shown in FIGS. 6A-6C described below), and/or other suitable optical components (beam-shaping and/or otherwise), as would be understood by one of ordinary skill in the art.

FIG. 5 illustrates a vertical-cavity surface-emitting laser (VCSEL) array capable of projecting arbitrary patterns of structured light with varying polarization states, according to an example. More specifically, FIG. 5 shows a VCSEL array 500 which may operate as a light source for an eye tracking system (such as, e.g., the eye tracking systems described in relation to the Figures described above) and a controller 550 which may control and/or send/receive data and other signals from the VCSEL array 500, and may further process and/or perform functions upon signals from other portions of the near-eye display device, such as the eye tracking system.

The controller 550 may include (and/or may be communicatively connected to) a processor 553 and a memory 555, which may be a non-transitory computer-readable storage medium. In some examples, the processor 553 in the controller 550 may perform any of the methods, functions, and/or processes described herein by executing instructions contained on the memory 555 and/or another suitable non-transitory computer-readable storage medium. In some examples, the controller 550 may be one or more of the eye tracking unit 130 and/or eye tracking module 118 in FIG. 1 discussed above, the controller 315 in FIG. 3 discussed above, the controller 430A/B in FIG. 4A-4B discussed above, any of the controller(s) 630A/B/D, 715, 815, 816, 930, 931, and/or 1040 in FIGS. 6A/B/D, 7A, 8A, 8B, 9A, 9B, and/or 10, respectively, discussed below, and/or any other processing or controlling module which may be used in the near-eye display device, as would be understood by one of ordinary skill in the art.

As shown in FIG. 5, VCSEL array 500 may include separate lines of VCSELs, where some of the lines may operate with a different polarization state. In some examples, the VCSEL array 500 may include repeating straight lines of VCSELs with the same polarization state, where VCSEL line(s) 510 (indicated by the white circles) may have one polarization state, while VCSEL line(s) 520 (indicated by the darker-shaded circles) and VCSEL line(s) 530 (indicated by the lighter-shaded circles) may have different polarization states. In some examples, the VCSELs in VCSEL line(s) 510 may have a polarization angle of 0°, while the VCSELs in VCSEL line(s) 520 may have a polarization angle of 90°, and the VCSELs in VCSEL line(s) 530 may have a polarization angle of 240°.

In other examples, the VCSEL line(s) may have different and/or more or less polarization angles—for instance, an example VCSEL array may include four repeating lines of VCSELs, where the VCSEL lines are set to −45°, 0°, +45°, and +90°. In other examples, the groupings of VSCELs may not be in straight lines (like those shown in FIG. 5) and the overall collection of VCSELs may not itself be an ordered array (like that shown in FIG. 5), but the overall collection of VCSELs may form other shapes or patterns and/or the groupings of VCSELs within the collection may also form other shapes or patterns (such as, e.g., circles within circles, blocks, and/or non-linear randomized groupings). In other examples, it is conceived that the groupings of VCSELs may be able to dynamically switch polarization states.

In examples according to the present disclosure, the VCSEL array may include VCSELs located at different locations, oriented in different orientations, and/or switchable on/off in one or more time sequences; moreover, the groupings of VCSELs having different polarization states may also be located at different locations, oriented in different orientations, and/or switchable on/off in one or more time sequences. Accordingly, a light source in examples according to the present disclosure may be a vertical-cavity surface-emitting laser (VCSEL) array configured to project arbitrary patterns by using groupings/sub-groups of VCSELs with different polarization states which may be static and/or dynamic.

In some examples, the VCSEL array 500 may be dynamically switched to ensure that only the zones best suited for illuminating the pupil and iris are being turned on as required. In such an implementation, feedback from the eye tracking system may be employed for determining the appropriate zones and power savings may be realized by only illuminating portions of the VCSEL array 500 at a time.

In some examples, the central emission wavelength of one, one or more groupings, and/or all of the VCSELs in the VCSEL array 500 may be modulated either instead of the polarization state or as well as the polarization state. In such implementations, a multichannel optical detector may be employed for demultiplexing spectral operation.

In some examples, one, one or more groupings, and/or all of the VCSELs in the VCSEL array 500 may be turned on and off and different rates (at, e.g., a multi-kHz frequency). In such implementations, a rapid detector such as an event camera may be employed, and lock-in detection and frequency de-multiplexing may be employed to de-couple non-structured light illumination (i.e., illumination that may originate from any other light source besides the VCSEL array 500).

As mentioned above, operation and control of one, one or more groupings, and/or all of the VCSELs in the VCSEL array 500 (operation/control such as, e.g., static and/or dynamic control of the polarization states) may be implemented in a variety of different ways, as would be understood by one of ordinary skill in the art. See, for example, the article mentioned above: Koerner et al., “Polarization Multiplexing in VCSEL-Arrays,” Proceedings of the Society of Photo-Optical Instrumentation Engineers (SPIE) 12439, Vertical-Cavity Surface Emitting Lasers XXVII (15 Mar. 2023), (i.e., SPIE-Photonics-West 2023, San Francisco, CA), which has already been incorporated by reference in its entirety herein. Such control/operation may be performed by the controller 550 and/or any other suitable control and/or processing means, as would be understood by one of ordinary skill in the art.

As mentioned above, FIGS. 6A through 6E are, broadly speaking, representations of light projection systems which allow for the projection of structured light with intensity and/or polarization states which may vary spatially and/or temporally, according to examples of the present disclosure. Any of the light projection systems in FIGS. 6A through 6E may be part of an eye tracking system (such as any of the eye tracking systems discussed herein). Similarly to FIGS. 4A-4B, instead of the user's eye itself or an eye box (such as shown in, e.g., FIGS. 7, 8A, 9A, and 10 discussed below), projection planes are shown and described in relation to FIGS. 6A through 6E. As shown in FIGS. 6A through 6E, structured light may be projected from a VCSEL array, through an optical assembly/stack, thereby forming the aforementioned projection plane, which may also be understood as representing the static and/or dynamic pattern formed by the structured light which is projected onto the user's eye.

In FIGS. 6A through 6E, different configurations of light projection systems are shown which allow for projecting light with spatially and/or temporally varying intensity profiles and spatially varying and/or temporally varying polarization profiles, according to various example. Generally speaking, FIG. 6A concerns a light projection system 600A which may allow for shifting intensity patterns in the projection plane as well as different polarization states within the projected structured light; FIGS. 6B and 6C concern a light projection system 600B which has optical elements which may allow for two different forms of beam shaping (such as, e.g., diffraction and polarization modulation); and FIGS. 6D and 6E concern a light projection system 600D, which has optical elements similar to the light projection system 600B, but which may also allow for phase shifting by switching groupings of VCSELs on and off sequentially.

In FIG. 6A, the light projection system 600A may include a VCSEL array 610A and an optical stack/assembly which may have a Pancharatnam-Berry phase (PBP) element 622 and a linear polarizer 625, all of which may be controlled by a controller 630A, and structured light is projected thereby onto polarization plane 690A. The PBP element 622 in the optical assembly/stack may change the polarization state of the light projected therethrough by the VCSEL array 610A, which is then further modified by the linear polarizer 625 before forming the structured light projected on the projection plane 690A. Accordingly, the projection plane 690A may have a structured intensity pattern projected upon it, and this pattern may shift as individual and/or groupings of VCSELs with different polarizations within the VCSEL array 610A are turned on and off. As would be understood by one of ordinary skill in the art, while having multiple emitters arranged in lines may provide speckle noise suppression at the expense of slightly blurred lines and a reduction of the field of view.

The VCSEL array 610A may be, for example, like the VCSEL array 500 in FIG. 5 or may be considerably less complicated, e.g., comprising only two different light sources locked into two different polarization states. In any event, individual VCSELs and/or groupings of VCSELs within the VCSEL array 610A may have different polarization states from each other and those polarization states may be static and/or dynamic. In some examples, the controller 630A may control the different structured light patterns by simply turning on and off the individual VCSELs and/or groupings of VCSELs within the VCSEL array 610A which have different polarization states.

The controller 630A may include (and/or may be communicatively connected to) a processor 633A and a memory 635A, which may be a non-transitory computer-readable storage medium. In some examples, the processor 633A in the controller 630A may perform any of the methods, functions, and/or processes described herein by executing instructions contained on the memory 635A and/or another suitable non-transitory computer-readable storage medium. In some examples, the controller 630A may be one or more of the eye tracking unit 130 and/or eye tracking module 118 in FIG. 1 discussed above, the controller 315 in FIG. 3 discussed above, the controller 430A/B in FIG. 4A-4B discussed above, the controller 550 in FIG. 5 discussed above, any of the controller(s) 715, 815, 816, 930, 931, and/or 1040 in FIGS. 7A, 8A, 8B, 9A, 9B, and/or 10, respectively, discussed below, and/or any other processing or controlling module which may be used in the near-eye display device, as would be understood by one of ordinary skill in the art.

FIGS. 6B and 6C illustrate a light projection system which allows for both intensity and polarization state modulation, according to an example. More specifically, the light projection system 600B in FIG. 6B includes two mechanisms for beam shaping which may employed, in addition to an VCSEL array, providing for intensity and polarization modulation simultaneously, according to an example.

In FIGS. 6B and 6C, the light projection system 600B may include a VCSEL array 610B and an optical stack/assembly which may have a Pancharatnam-Berry phase (PBP) element 622 and a diffractive optical element (DOE) 627, all of which may be controlled by a controller 630B, and structured light is projected thereby onto polarization plane 690B. FIG. 6B is a side view of a block diagram of the light projection system 600B, while FIG. 6C is a planar view of the projection plane 690B. The PBP element 622 in the optical assembly/stack may change the polarization state of the light projected therethrough by the VCSEL array 610B, which is then further modified by the DOE 627 before forming the structured light projected on the projection plane 690B.

The DOE 627 may create multiple copies of the lines of VCSELs in the VCSEL array 610B lines which may create multi-line or fringe illumination at the projection plane 690B. For example, this configuration may create fringes from left to right in the illumination plane. The PBP element 627 may create polarization modulation (for example, fringes as defined by zones of rotating linearly polarized light from top to bottom). The spacing between adjacent columns of linearly polarized VCSELs may be selected so that the same linear polarization states (such as, e.g., horizontal polarization) overlap on top of each other. In such an example, the sources may be linearly polarized with same angle.

Accordingly, the VCSEL array 610B with the PBP element 622 and the DOE element 627 may be configured to project the projection plane 690B which, as represented graphically in FIG. 6C, may have intensity modulation 692C and polarization modulation 694C at the same time. In some examples, the projected pattern of the projection plane 690B may be detected with polarization-sensitive camera.

The VCSEL array 610B may be large or small, simple or complex, or like the VCSEL array 500 in FIG. 5, depending on the needs and requirements of the specific implantation, as would be understood by one of ordinary skill in the art. Individual VCSELs and/or one or more groupings of VCSELs within the VCSEL array 610B may have different polarization states, which may be static or dynamically changeable. In some examples, the controller 630B may help generate the different structured light patterns by controlling the polarization states, intensity, location, on/off condition, and other parameters of one or more individual VCSELs and/or one or more groupings of VCSELs within the VCSEL array 610B. The controller 630B may include (and/or may be communicatively connected to) a processor 633B and a memory 635B, which may be a non-transitory computer-readable storage medium. In some examples, the processor 633B in the controller 630B may perform any of the methods, functions, and/or processes described herein by executing instructions contained on the memory 635B and/or another suitable non-transitory computer-readable storage medium. In some examples, the controller 630B may be one or more of the eye tracking unit 130 and/or eye tracking module 118 in FIG. 1 discussed above, the controller 315 in FIG. 3 discussed above, the controller 430A/B in FIG. 4A-4B discussed above, the controller 550 in FIG. 5 discussed above, any of the controller(s) 715, 815, 816, 930, 931, and/or 1040 in FIGS. 7A, 8A, 8B, 9A, 9B, and/or 10, respectively, discussed below, and/or any other processing or controlling module which may be used in the near-eye display device, as would be understood by one of ordinary skill in the art.

FIGS. 6D and 6E illustrate a light projection system which allows for phase shifting as well as both intensity and polarization state modulation, according to an example. More specifically, the light projection system 600B in FIG. 6B includes the same two mechanisms for beam shaping employed in the light projection system 600B, which may provide for intensity and polarization modulation simultaneously, but also changes the polarization states of the VCSELs in the VCSEL array in order to provide phase shifting, according to an example.

In FIGS. 6D and 6E, the light projection system 600D, similarly to the light projection system 600B, may have a VCSEL array 610D and an optical stack/assembly which may include a Pancharatnam-Berry phase (PBP) element 622 and a diffractive optical element (DOE) 627, all of which may be controlled by a controller 630D, and structured light is projected thereby onto polarization plane 690D. FIG. 6D is a side view of a block diagram of the light projection system 600D, while FIG. 6E is a planar view of the projection plane 690D. Similar to FIG. 6B, the PBP element 622 may change the polarization state of the light projected therethrough by the VCSEL array 610D, thereby providing for polarization modulation, while the DOE 627 may create multiple copies/fringes in the resulting structured light projected on the projection plane 690D, thereby providing for intensity modulation.

However, in FIG. 6D, each column of VSCELs in the VCSEL array 610D may have the same polarization state, while each separate column of VCSELs has a different polarization state from the rest. In some examples, the VCSEL columns are turned on sequentially, thereby achieving phase shifting in the polarization domain.

Accordingly, groupings of VCSELs in the VCSEL array 610D may be configured to project the projection plane 690D which, as represented graphically in FIG. 6E, may have phase shifting as well as simultaneous intensity modulation 692E and polarization modulation 694E.

The VCSEL array 610D may have any shape or format, depending on the needs and requirements of the specific implantation, as would be understood by one of ordinary skill in the art. Individual VCSELs and/or one or more groupings of VCSELs within the VCSEL array 610D may have dynamically changeable polarization states, intensities, location, on/off condition, and other parameters. The controller 630D may individually control the polarization states, intensity, location, on/off condition, and other parameters of one or more individual VCSELs and/or one or more groupings of VCSELs within the VCSEL array 610D. The controller 630D may include (and/or may be communicatively connected to) a processor 633D and a memory 635D, which may be a non-transitory computer-readable storage medium. In some examples, the processor 633D in the controller 630D may perform any of the methods, functions, and/or processes described herein by executing instructions contained on the memory 635D and/or another suitable non-transitory computer-readable storage medium. In some examples, the controller 630D may be one or more of the eye tracking unit 130 and/or eye tracking module 118 in FIG. 1 discussed above, the controller 315 in FIG. 3 discussed above, the controller 430A/B in FIG. 4A-4B discussed above, the controller 550 in FIG. 5 discussed above, any of the controller(s) 715, 815, 816, 930, 931, and/or 1040 in FIGS. 7A, 8A, 8B, 9A, 9B, and/or 10, respectively, discussed below, and/or any other processing or controlling module which may be used in the near-eye display device, as would be understood by one of ordinary skill in the art.

Any of the processors 633A, 633B, and/or 633D in FIGS. 6A, 6B, and/or 6D, respectively, and/or any of the other possible processing means in accordance with the present disclosure as would be understood by one of ordinary skill in the art, may be, or may include, one or more programmable general-purpose or special-purpose single—and/or multi-chip processors, a single—and/or multi-core processors, microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices. Any of the memories 635A, 635B, and/or 635D in FIGS. 6A, 6B, and/or 6D, respectively, and/or any of the other possible non-transitory computer-readable media in accordance with the present disclosure as would be understood by one of ordinary skill in the art, may be, or may include, one or more read-only memory (ROM), flash memory, and/or random access memory (RAM)—any of which may be the main memory into which an operating system, various application programs, and/or a Basic Input-Output system (BIOS) which controls basic hardware operation such as the interaction with one or more peripheral components may be loaded/stored. Code or computer-readable instructions to implement the methods, functions, and/or operations discussed and/or described herein may be stored in any suitable computer-readable storage media and/or may be received via one or more communication/transmission interfaces, as would be understood by one of ordinary skill in the art.

In some examples, instead of fixed linear polarizers in front of the VCSELs, meta-surface based VCSELs with electrically switchable polarization may be used for individual emitters. The VCSELs may also be replaced with an array of micro-LED or micro-OLED light sources allowing speckle-free operation and increased emission angles.

In yet other examples, the VCSEL array may be dynamically switched to ensure that only the zones required for illuminating pupil and iris are being turned on as needed. This example implementation may need feedback from the eye tracking system and allow power savings by only illuminating the areas of interest.

In further examples, a configuration similar to the light projection systems 600A, 600C, and/or 600C may module the central emission wavelength modulated instead of polarization state. A multi-channel optical detector may be used to de-multiplex spectral operation in the wavelength modulation example. In yet further examples, the light sources may be turned on/off at different rates (e.g., multi-kHz) using a configuration similar to the light projection systems 600A, 600C, and/or 600C. A rapid detector such as an event camera may be used to capture the pattern. Lock-in detection and frequency de-multiplexing may be used to de-couple illumination that originates from different light sources.

### III. User Authentication & Liveness Detection

In examples according to the present disclosure, the eye tracking system of the near-eye display device may perform double duty, because the eye tracking system may be used to perform user authentication and liveness detection in addition to eye tracking. In some examples, the eye tracking system uses a speckle pattern produced by one or more vertical-cavity surface-emitting lasers (VCSELs) acting as a coherent illumination source. In such examples, the laser light source or vertical-cavity surface-emitting lasers (VCSELs) may be sufficiently coherent and have a sufficiently narrow spectral width so that detectable speckle patterns can be produced and recorded with the eye tracking camera. An example of this is described in reference to FIG. 7 below.

FIG. 7 is a top view of the near-eye display device 700 in the form of a pair of glasses (or other similar eyewear) which may be used in accordance with examples of the present disclosure. Although only the relevant components around and directed to the user's right eye are labelled in FIG. 7, substantially identical components may be similarly directed to the user's left eye in the near-eye display device 700. In some examples, the near-eye display device 700 may be a specific example of near-eye display 120 of FIG. 1 and may be configured to operate as an augmented reality (AR) display and/or a mixed reality (MR) display.

As shown in FIG. 7, the near-eye display device 700 may include a frame 705, a display 710, eye tracking camera(s) 720, coherent illumination source(s) 725, and controller 715. Many of these components are similar to similarly-numbered components in FIG. 3, and thus may not be described in complete detail again. In some examples, the display 710 may include display electronics and/or display optics to present media or other content to a user, similar to components described with respect to FIGS. 1, 2A-2C, and 3. For example, as described above with respect to the near-eye display 120 of FIG. 1, the display 710 may include a liquid crystal display (LCD) display panel, a light-emitting diode (LED) display panel, or an optical display panel (e.g., a waveguide display assembly). In some examples, the display 710 may also include any number of optical components, such as waveguides, gratings, lenses, mirrors, etc. In some examples, in a near-eye display system, light from a surrounding environment may traverse a “see-through” region of the display 710 to reach a user's eyes, while images are also projected for the user to see as part of an augmented reality (AR) display and/or a mixed reality (MR) display. For example, in a near-eye display system such as near-eye display device 700, light of projected images may be coupled into a transparent substrate of a transparent waveguide (acting as the display 710), propagate within the waveguide, be coupled with light from the user's actual environment, and directed out of the waveguide at one or more locations towards a user's eye(s).

In some examples, the near-eye display device 700 may include an eye tracking system, which may include a coherent illumination source(s) 725, and an eye tracking camera(s) 720 or other image sensor facing inwards towards the user, and a controller 715. In an example shown in FIG. 7, an eye tracking system of the near-eye display device 700 may comprise the coherent illumination source(s) 725 and the camera(s) 720 (hereinbelow, sometimes referred to as “the eye tracking camera(s) 720” in some examples and/or more generally as “the camera(s) 720” in other examples), although examples of the present disclosure are not so limited—i.e., the coherent illumination source(s) 725 and the eye tracking camera(s) 720 or other image sensor according to the present disclosure may be separate from the eye tracking system of the near-eye display device 700. Similarly, in some examples, the controller 715 may control at least the camera(s) 720 and may or may not be part of the eye tracking system of the near-eye display device 700. Similarly, in some examples, the controller 715 may or may not control the coherent illumination source(s) 725.

In some examples where the controller 715 may control one or more of the eye tracking camera(s) 720 and the coherent illumination source(s) 725, the controller 715 may perform eye tracking by calculating/determining the eye's position or relative position, which may include the orientation, location, and/or gaze of the user's eye. In some examples, the near-eye display device 700 may use the orientation of the eye to introduce depth cues (e.g., blur the displayed image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, and/or any combination thereof. In some examples, because the orientation may be determined for both eyes of the user, the eye-tracking system may determine where the user is looking and/or predict any user patterns, etc.

In other examples where the controller 715 may not be part of the eye tracking system, the controller 715 may only determine whether the eye is stationary (i.e., motionless, still, not currently moving), and retrieve, and/or control other components to take, images of the stationary eye in order to perform user authentication and/or liveness detection in accordance with the present disclosure, as described in detail in reference to several examples below.

In some examples, the controller 715 may be communicatively connected with a memory, which may be at least one non-transitory computer-readable storage medium storing instructions executable by the controller 715. The controller 715 may include multiple processing units, and those multiple processing units may further execute instructions in parallel. The at least one non-transitory computer-readable storage medium may be any memory, such as a hard disk drive, a removable memory, or a solid-state drive (e.g., flash memory or dynamic random access memory (DRAM)). In various examples, the controller 715 may be further subdivided into multiple devices (for example, the functions of the controller 715 may be separated among various components, such as a digital signal processing (DSP) chip for eye tracking analysis as well as a Central Processing Unit (CPU) for controlling, e.g., the coherent illumination source(s) 725). In some examples, the controller 715 may not be disposed on or within the glasses portion of the near-eye display device 700 as shown in FIG. 7, but instead may be separate from the glasses portion of the near-eye display device 700. In such examples, the controller 715 may be disposed in a separate control module or a console/control hand device connected by wire and/or wirelessly with the glasses portion of the near-eye display device 700.

In some examples, both the eye tracking camera(s) 720 and the coherent illumination source(s) 725 of the eye tracking system may be generally targeting the user's eye in eye box 750, where the coherent illumination source(s) 725 may project light into an eye of the user (located somewhere within eye box 750) and the eye tracking camera(s) 720 may capture reflections from the light projected onto the eye of the user. In some examples, the eye tracking camera 720 may be a digital camera which may use semiconductor imaging sensors and may or may not use optics and a variable aperture. In some examples, the optics, aperture, etc., may be effectively replaced by digital signal processing (DSP) of the data received by the semiconductor imaging sensors. In some examples, the eye tracking camera(s) 720 may be at least one of a charge-coupled device (CCD) or an active pixel sensor, also known as a complementary metal oxide semiconductor (CMOS) sensor. In other examples, the eye tracking camera(s) 720 may be other forms of metal oxide semiconductor (MOS) based sensors, such as, e.g., an n-type metal oxide semiconductor (nMOS) integrated circuit chip, or a modified metal oxide semiconductor (MOS) dynamic random access memory (RAM) chip. In some examples, eye tracking camera(s) 720 may be a single photon avalanche diode (SPAD) sensor.

In some examples, the coherent illumination source(s) 725 may be a vertical-cavity surface-emitting laser (VCSEL) diode. In other examples, the coherent illumination source(s) 725 may be almost any light and/or radiation source, as would be understood by one of ordinary skill in the art, such as, e.g., a laser, a light emitting diode (LED), a side-emitting laser diode, a superluminescent light-emitting diode (SLED), and/or an array or multitude of any of the same. In some examples, the coherent illumination source(s) 725 may have both electronic and moving mechanical parts, such as scanning projectors, like, for example, a micro-electromechanical system (MEMS) or a micro-optoelectronic system (MOEMS), such as a digital micro mirror device, reflecting light from a light source (e.g., a laser). In some examples, the coherent illumination source(s) 725 may be, for example, a digital video projector, a spatial light modulator (such as, e.g., an electrically-addressed spatial light modulator (EASLM) or an optically-addressed spatial light modulator (OASLM)), a deformable mirror or an array of deformable mirrors, a galvanometric scanner or modulator, or an acousto-optic scanner or modulator (such as, e.g., a Bragg cell or acousto-optic deflector (AOD), and/or an interferometric modulator display (IMOD), in which an electrically switched light modulator comprising a microscopic cavity that is switched on and off using thousands of micro-electromechanical system (MEMS) elements.

In some examples, the coherent illumination source(s) 725 may project light/radiation in the ultraviolet spectrum (e.g., about 200-350 nm), the visual light spectrum (e.g., about 350 nm-750 nm), the infrared spectrum (e.g., about 750 nm-1000 nm), and/or any electromagnetic radiation spectrum capable of both eye tracking and user authentication/liveness detection in accordance with examples of the present disclosure, as would be understood by one of ordinary skill in the art. In some examples, the coherent illumination source(s) 725 projects light in the infrared (IR) spectrum.

In some examples, to perform eye tracking, the coherent illumination source(s) 725 may project a pattern upon the user's eye, such as, for example, a statistically random pattern (such as, e.g., a pattern of dots or a pattern of speckles), an interference pattern (such as, e.g., a moire pattern or a fringe pattern), a sinusoidal pattern, a binary pattern, a multi-level pattern (such as, e.g., a multi-level grayscale pattern), a code-based pattern, a color-based pattern, and a geometrical pattern (such as, e.g., a triangular, pyramidal, or trapezoidal pattern). Moreover, in various examples of the present disclosure, there may be only one projected pattern, or a multitude of patterns, or a series of related patterns, which may be projected either separately, in a series, or simultaneously, as would be understood by one of ordinary skill in the art. In some examples, periodic patterns (such as, e.g., fringe patterns) and/or non-periodic patterns (such as, e.g., speckle patterns) may be used.

As stated above, the eye tracking system in the near-eye display device 700 in FIG. 7 may include the eye tracking camera(s) 720, the coherent illumination source(s) 725, and the controller 715 performing the eye tracking, as well as possibly controlling the eye-tracking camera(s) 720 and/or the coherent illumination source(s) 725. As would be understood by one of ordinary skill in the art, any of a large variety of eye tracking techniques may be employed, depending upon, for example, the light sources used, the image sensors used, the processing capabilities of the near-eye display device, the form factor of the near-eye display device, etc.

As mentioned above, the eye tracking system of the near-eye display device 700 performs double duty in the example of FIG. 7, because the eye tracking system may be used to perform user authentication and liveness detection in addition to eye tracking. In some examples, the eye tracking system uses a speckle pattern produced by a vertical-cavity surface-emitting laser (VCSEL) diode acting as the coherent illumination source(s) 725. In such examples, the laser light source or vertical-cavity surface-emitting laser (VCSEL) diode may be sufficiently coherent and have a sufficiently narrow spectral width so that detectable speckle patterns can be produced and recorded with the eye tracking camera(s) 720.

In such examples, laser speckle contrast imaging (LSCI) or laser speckle imaging (LSI) may be used, over time periods when the eye is not moving, to map and measure the velocity of blood flow through the capillaries in the areas outside the pupil of the eye, e.g., in the sclera, corneal region, and even the skin immediately adjacent to the eye. In other examples where the controller 715, the camera(s) 720, and/or the coherent illumination source(s) 725 may be separate from any eye tracking system, the controller 715, the camera(s) 720, and/or the coherent illumination source(s) 725 may employ laser speckle contrast imaging (LSCI) or laser speckle imaging (LSI) separately from any eye tracking function in accordance with the present disclosure.

In laser speckle contrast imaging (LSCI) or laser speckle imaging (LSI), a laser projects a speckle pattern on an object or surface and the reflections of that speckle pattern are imaged and analyzed to, for example, detect motion where there is an otherwise motionless background. Specifically, in a temporal series of images (or frames), the pixel areas which fluctuate, or are attenuated, or blurred, are the specific areas where movement has occurred. Because the superficial retinal tissue of the eye is a highly scattering medium, over time periods where the eye is not moving, the background tissue, which is not moving, produces a constant speckle pattern, while the blood vessels or capillaries near the surface generate temporally varying speckle patterns due to the flow of scattering particles—i.e., the red blood cells flowing through the capillaries. Speckle statistics may be calculated using the neighboring (background) pixels in comparison with the blurred/moving (capillary) pixels to both create blood vessel/capillary maps of the eye and determine relative flow magnitudes-either or both of which may be used as uniquely identifying characteristic of a single human being. Moreover, the very existence of flowing blood provides a strong indication that the eye of a living human being is being imaged—i.e., liveness detection.

Thus, in examples in accordance with the present disclosure, during sufficiently long enough time periods when the eye is stationary (i.e., motionless, still, not currently moving), data may be collected from the eye tracking camera(s) 720 to form a time-series sequence of frame/images. In some examples, a sufficiently long enough time period may be less than a second, when a few dozen to a few hundred frames/images may be taken/obtained. Speckle contrast (which is a function of the exposure time of the camera and is related to the autocovariance of the intensity fluctuations in individual speckles), or any other suitable descriptor of temporal speckle statistics, is computed over the time series sequence of frame/images, whereby the controller 715 may extract the location of the sub-surface blood vessels (e.g., capillaries) as well as the velocity of the blood flow through those blood vessels. In such examples, the controller 715 may determine a map of the surface capillaries of the eye and/or the blood flow dynamics or hemodynamics of those capillaries, including, e.g., changes in blood flow within the capillaries; the viscosity of the blood plasma; the shapes and dynamics of the red blood cells; the osmotic pressure within the capillaries; hemodilution; the turbulence and velocity of blood flow; vascular resistance, stress, capacitance, and/or wall tension; etc., all of which measurements/criteria/diagnostic tools would be known and understood by one of ordinary skill in the art. In such a manner, examples in accordance with the present disclosure provide a cost-effective solution for detecting natural features of the human eye which are difficult to reproduce artificially. In some examples, data acquisition during the pupil's stationary state may last several data acquisition frames. Depending on a sensing frame rate, the actual stationary state may last 10-100 milliseconds.

In some examples, a few dozen to a few hundred frames/images in a single second may be used to perform such processing. In some examples, the frames/images may not all need to be in sequence to perform the user authentication and liveness detection in accordance with the present disclosure. In some examples, out-of-sequence frames may be preferred as the sensing method may also be impacted by speckle de-correlation time. Speckle decor relation time is effectively affected by the need to obtain sufficient physical change (i.e., blood cells to move sufficiently) to have the change in speckle pattern. Alignment of the images (to landmarks, such as pupil, iris corners of the eye) is sufficient for performance of statistical analysis on speckle patterns at same physical locations. Other techniques for data processing may also be employed, as would be understood by one of ordinary skill in the art.

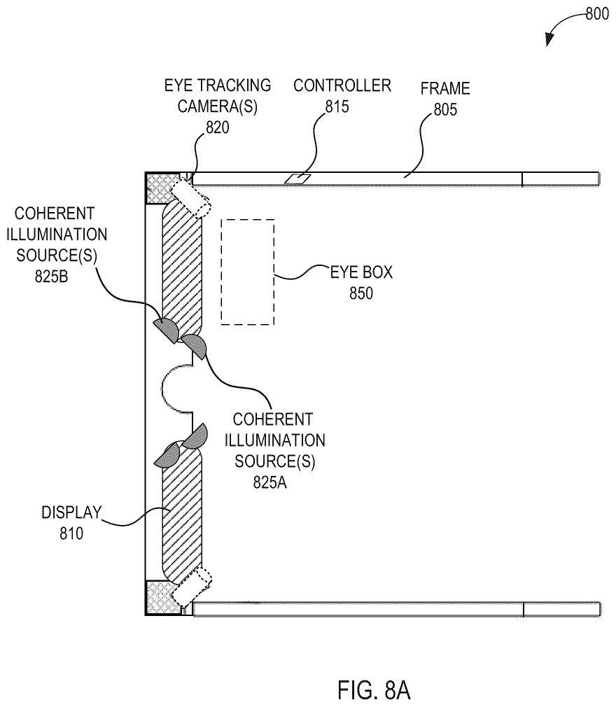

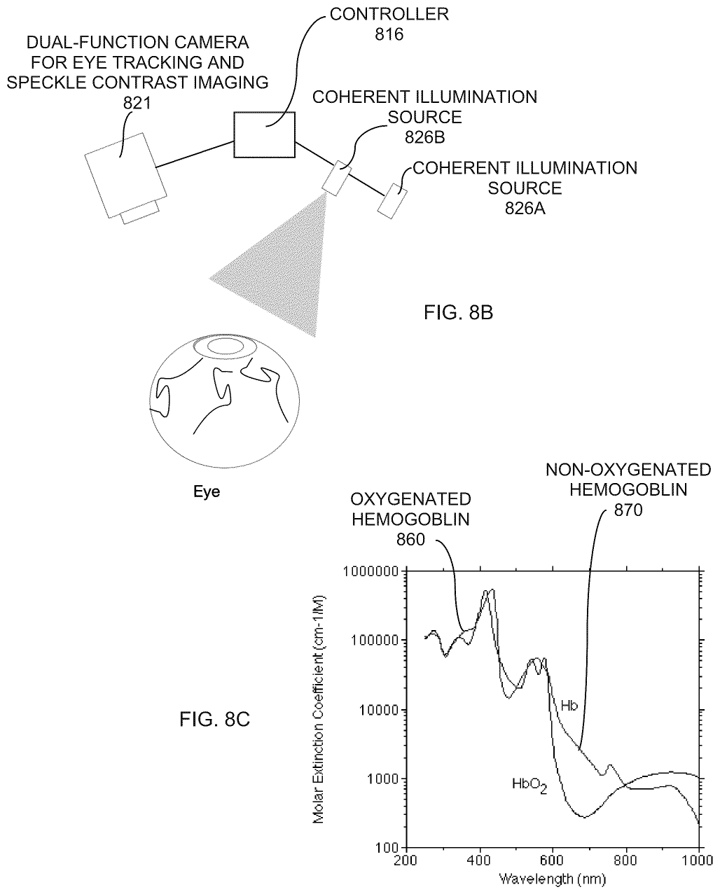

FIG. 8A illustrates a top view of a near-eye display device in the form of a pair of glasses having multispectral illumination sources, which may be used for user authentication and liveness detection, according to an example. As shown in FIG. 8A, a near-eye display device 800 may include a frame 805, a display 810, a controller 815, an eye box 850, and an eye tracking camera(s) 820 in a similar manner as the frame 705, the display 710, the controller 715, the eye box 750, and the eye tracking camera(s) 720 in FIG. 7.

In some examples, the near-eye display device 800 in FIG. 8A may include multiple coherent illumination sources, where one or more of the multiple coherent illumination sources may have different central wavelengths than the other coherent illumination sources. In such examples, the different central wavelengths may be used to isolate and focus on different features, objects, phenomena, etc., of the user's eye and contiguous skin tissue, as would be understood by one of ordinary skill in the art.

In an example shown in FIG. 8A, the near-eye display device may include two separate but closely spaced illumination sources: a coherent illumination source 825A and a coherent illumination source 825B. In such examples, the central wavelength of the coherent illumination source 825A may be different than the central wavelength of the coherent illumination source 825B. In such examples, the central wavelengths of the two sources permit ratiometric measurements of different factors, characteristics, or qualities of the user's eye, the contiguous skin tissue, the capillaries, the sclera, the iris, the blood flow dynamics or hemodynamics, etc., all of which measurements/criteria/diagnostic tools would be known and understood by one of ordinary skill in the art. As used herein, “ratiometric” may be understood to refer to ratio of measurements of two or more features, objects, phenomena, etc., which may serve as yet another indicia for uniquely identifying a human being and/or detecting whether the user is a live subject or not. As indicated above, in some examples, the different spectral projections of the different coherent illumination source(s) 825 may not employ any ratiometric analysis, but rather may be used to isolate and/or calculate other factors, characteristics, or qualities of the user's eye and contiguous skin tissue which may be useful in uniquely identifying a human being and/or detecting whether the user is a live subject or not.

In such examples, time series data may be captured by eye tracking camera(s) 820 either sequentially from reflections from the user's eye of light projected in a series from one or the other of the coherent illumination source 825A and the coherent illumination source 825B (producing two sequences, each taken in only one wavelength), or in an interlaced fashion from one or the other of the coherent illumination source 825A and the coherent illumination source 825B (where, e.g., every other frame/image in the sequence has a different wavelength). In some examples, the pattern of the time series for lighting by the different central wavelengths may only be initiated when the controller 815 detects the eye is not moving, or the lighting pattern may be preprogrammed to repeat in a periodic manner (where the controller 815 only isolates and/or analyzes the data collected when it is determined the eye was still during the lighting pattern), or the lighting pattern may be dynamically employed based on a detected pattern of the eye's movement and non-movement, or any of the like, as would be understood by one of ordinary skill in the art.

In some examples, more or less of the coherent illumination source(s) 825 may be employed than shown in FIG. 8A. For instance, a single coherent illumination source 825 may be capable of projecting light/radiation of two or more different wavelengths, while in other instances, multiple coherent illumination source(s) may be employed, each with its own unique wavelength.

FIG. 8B illustrates a schematic block diagram of a near-eye display device having multispectral illumination sources, which may be used for user authentication and liveness detection, according to an example. In FIG. 8B, a dual function camera for eye tracking and speckle contrast imaging 821 and two coherent illumination sources 826A and 826B may be operably connected to a controller 816 in a similar manner as the eye tracking camera(s) 820 and the two coherent illumination sources 825A and 825B are operably connected to the controller 815 in FIG. 8A. Also similarly to FIG. 8A, the two separate but closely spaced coherent illumination sources 826A and 826B may have different central wavelengths: specifically, the central wavelength of the coherent illumination source 826A may be 850 nm and the central wavelength of the coherent illumination source 825B may be 1000 nm. In such an example, the central wavelengths of the two sources permit ratiometric measurements of oxygenated and non-oxygenated hemoglobin, as explained below in reference to FIG. 8C.

FIG. 8C is a graph of the molar extinction coefficient vs. wavelength of oxygenated and non-oxygenated hemoglobin, which characteristics may be used for user authentication and/or liveness detection by the near-eye display devices in FIGS. 8A and 8B, according to an example. As shown in FIG. 8C, the difference in the molar extinction coefficient (a measure of how strongly a substance absorbs light at a particular wavelength) between oxygenated hemoglobin 860 and non-oxygenated hemoglobin 870 is large at the wavelengths of 850 nm and 1000 nm. Thus, when the central wavelength of the coherent illumination source 826A may be 850 nm and the central wavelength of the coherent illumination source 825B may be 1000 nm in FIG. 8B, an analysis of the ratio of oxygenated hemoglobin and non-oxygenated hemoglobin in the user's capillaries may be performed by the controller 816, of which the results may serve as yet another indicia for uniquely identifying a human being and/or detecting whether the user is a live subject or not.

In some examples, 750 nm may also be used and be more beneficial for better contrast, but it may also be more visible to the user. With 750 nm wavelength, patterns that shape the light to minimize the illumination of the pupil (and in turn the visibility of the sensing light) may need to be used.

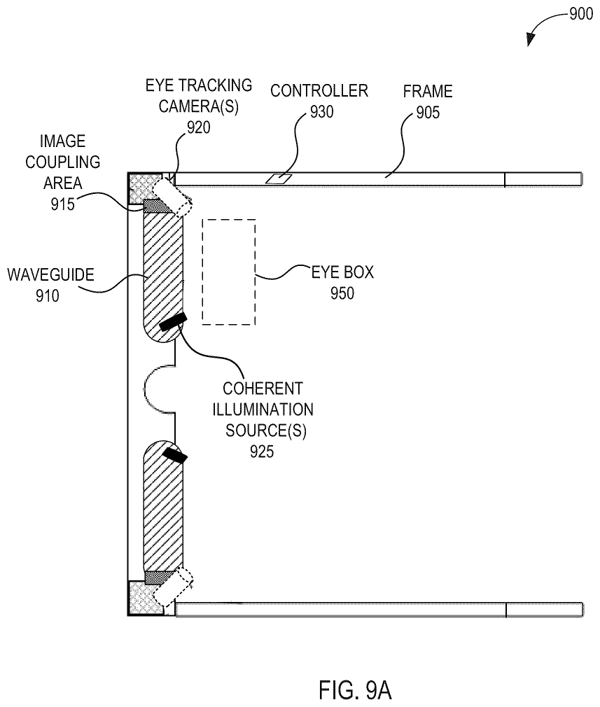

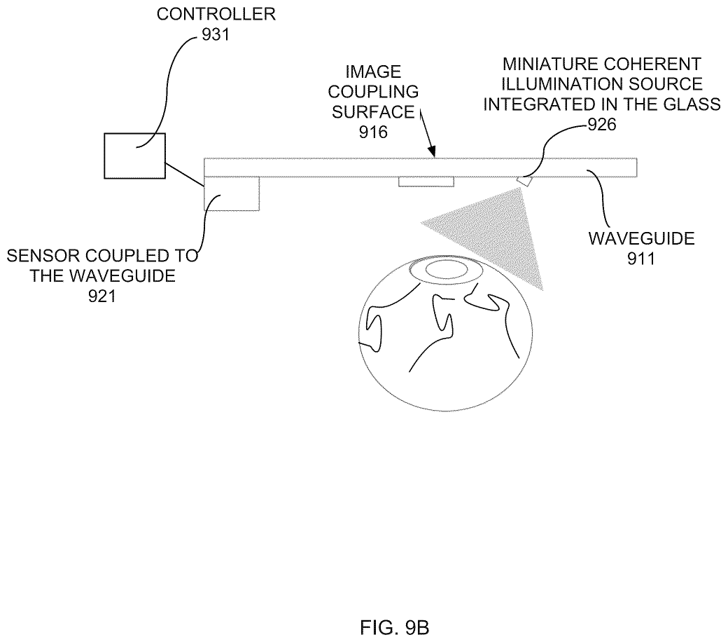

FIG. 9A illustrates a top view of a near-eye display device in the form of a pair of glasses having a waveguide with integrated illumination source(s), which may be used for user authentication and liveness detection, according to an example. As shown in FIG. 9A, a near-eye display device 900 may include a frame 905, a controller 930, an eye tracking camera(s) 920, and an eye box 950 In a similar manner as the frame 705, the controller 715, the eye tracking camera(s) 720, and the eye box 750 in FIG. 7.

The near-eye display device 900 in FIG. 9A may be an augmented reality (AR)/virtual reality (VR) device, where the display takes the form of a waveguide 910. In some examples, the waveguide 910 may be a variable-phase liquid crystal diffraction grating comprised of two parallel transparent/semi-transparent elements between which a liquid crystal forms a thin film. In some examples, the liquid crystal may be a nematic liquid crystal, a cholesteric liquid crystal, or any liquid crystal capable of manipulation by the application of an electric field, as would be understood by one of skill in the art. In some examples, light sources/emitters may be positioned adjacent to the liquid crystal such that their light is refracted through the liquid crystal medium, to which an electric field Is applied by a thin film of electrically conductive and semi-transparent material to manipulate the liquid crystal and thusly the light being projected therethrough. In other examples, at least one transparent layer in the waveguide 910 may be formed of optical polymers, plastic, glass, transparent wafers (e.g., silicon carbide (SIC) wafers), amorphous silicon, silicon oxide (SiO₂), silicon nitride (SiN), titanium oxide (TiO), and/or any other transparent materials used for such a purpose, as would be understood by one of ordinary skill in the art.

In such examples as shown in FIG. 9A, the controller 930, which may or may not be the same controller performing the user authentication/liveness detection in the examples, controls the light emitters (not shown) and the liquid crystal medium such that a light image is projected on and through image coupling area(s) 915 into waveguide 910 to be manipulated and then the resulting light image is projected through a decoupling area (not labelled) into the eye box 950. In such examples, an augmented reality (AR) environment may be generated when the user sees both the projected light image as well as the light passing through the waveguide from the local environment.

In the example shown in FIG. 9A, the coherent illumination source(s) 925 is integrated directly into the waveguide 910 by being directly embedded into the transparent element facing the eye box 950. In other examples, the coherent illumination source(s) 925 is integrated into the waveguide optical assembly, for example, adjacent to, near, and/or as one of the light emitters (not shown) projecting a light image through the image coupling area(s) 915. In such an example using red, green, and blue (RGB) light emitters, the coherent illumination source(s) 925 may be added as part of an array formed by the red, green, and blue (RGB) light emitters, or affixed near to the array of red, green, and blue (RGB) light emitters, or collocated in such a manner as to have its light beam enter the image coupling area(s) 915, as would be understood by one of ordinary skill in the art. In some examples, one or more of the pre-existing array of light emitters forming the light image may also be used as the coherent illumination source(s) 925 in accordance with the present disclosure. In other examples, the coherent illumination source(s) 925 is integrated into the waveguide optical assembly, for example, at locations and positions separate and distinct from the light emitters (not shown) which project the light image through the image coupling area(s) 915.

As shown in the example of FIG. 9A, the eye tracking camera(s) 920 may be located in a similar fashion as FIGS. 3, 7, 8A, and 8B; however, in some examples, the eye tracking camera(s) 920 may also be integrated into, or otherwise affixed/attached to, the waveguide 910. In such examples, this may be accomplished in a similar manner as, or differently than, the technique used for integrating the coherent light illumination source(s) 925 into the waveguide 910. In such examples, the eye tracking camera(s) 920 may be located adjacent to, near, and/or as one of the light emitters (not shown) projecting a light image through the image coupling area(s) 915.

FIG. 9B illustrates a schematic block diagram of a near-eye display device having a waveguide in which illumination source(s) may be disposed, which may be used for user authentication and/or liveness detection, according to an example. In FIG. 9B, a sensor 921 is coupled to a waveguide 911 with image coupling surface 916 and a miniature coherent illumination source 926 is integrated into the glass of the waveguide 911, where a controller 931 may be operably connected to the sensor 921 and the miniature illumination source 926 in a similar manner as the controller 930 in FIG. 9A may be operably connected to the eye tracking camera(s) 920 and the coherent illumination source(s) 925 integrated directly in the waveguide 910 in FIG. 9A.

As shown in FIG. 9B, the miniature illumination source 926 may be a liquid crystal diode (LCD), an organic light-emitting diode (OLED), a micro-light-emitting diode (micro-LED), a pico-projector, a liquid crystal on silicon (LCOS) display/projector, one or more fiber-coupled light sources, and/or one or more photonic integrated circuits (PICs), which may be transparent, semi-transparent, and/or as small as 200 microns, thereby not interfering with the user's view. As would be understood by one of ordinary skill in the art, such components may be constructed on/in the waveguide using photolithography and the appropriate photonic materials, such as, e.g., amorphous silicon, silicon oxide (SiO₂), silicon nitride (SiN), titanium oxide (TiO), and/or any other suitable transparent materials. In some examples, the sensor 921 may also be, at least in part, a photonic integrated circuit (PIC).

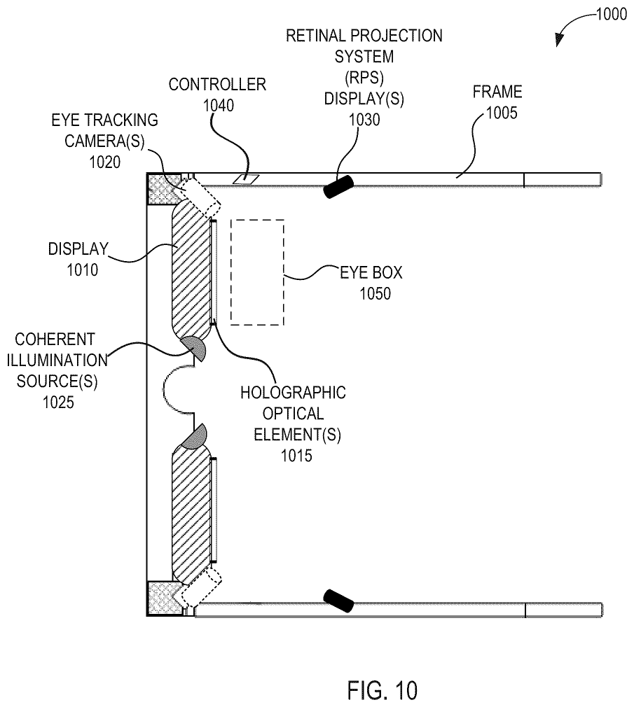

FIG. 10 illustrates a top view of a near-eye display device in the form of a pair of glasses having a retinal projection system (RPS), which may be used for user authentication and liveness detection, according to an example. As shown in FIG. 10, a near-eye display device 1000 may include a frame 1005, an eye tracking camera(s) 1020, a coherent illumination source(s) 1025, a controller 1040, and an eye box 1050 in a similar manner as the frame 705, the eye tracking camera(s) 720, the coherent illumination source(s) 725, the controller 715, and the eye box 750 in FIG. 7.

The near-eye display device 1000 in FIG. 10 may have a retinal projection system (RPS) which may include a retinal projection system (RPS) display(s) 1030 and a holographic optical element(s) (HOE) 1015 disposed in a display 1010. The retinal projection system (RPS) display(s) 1030 may project a light image onto the holographic optical element(s) (HOE) 1015 which may then be reflected directly into the user's retinal area in the eye box 1050. The near-eye display device 1000 in FIG. 10 may be an augmented reality (AR)/virtual reality (VR) device, where the user sees both the projected light image combined with the light passing through the display(s) 1010 from the local environment.

In some examples, the retinal projection system (RPS) of the near-eye display device 1000 in FIG. 10 uses the holographic optical element(s) (HOE) 1015 to focus the light of display images from the retinal projection system (RPS) display(s) 1030 to converge on the pupil of the user's eye. Because the focus converges on the pupil of the user's eye, the eye tracking system including the eye tracking camera(s) 1020 and the coherent illumination source(s) 1025 may be needed to closely track the pupil's location to suitably direct the display images. As would be understood by one of skill in the art, the means for suitably adjusting the focus of the retinal projection system (RPS) display(s) 1030 may depend on the specific configuration of the retinal projection system (RPS), such as a combination of holographic optical element (HOE) and steerable mirror, a mechanically moving holographic optical element (HOE) module, an array of light emitting diodes (LEDs) synchronized with the eye tracking system, or a waveguide (like the example shown in the figures described above) using multiplexed holographic optical elements (HOEs).

In the example shown in FIG. 10, the retinal projection system (RPS) display(s) 1030 may project light in the near infrared (e.g., in the 750 nm-1400 nm band) and reflections of the projected light showing the retinal vasculature pattern of the user's eye may be recorded by, for example, the eye tracking camera(s) 1020. In this manner, the retinal vasculature pattern of the user's eye may be used for user authentication/liveness detection instead of, or in addition to, the scleral patterns, such as the capillary mapping and blood flow dynamics generated by the examples in FIGS. 7-9B.

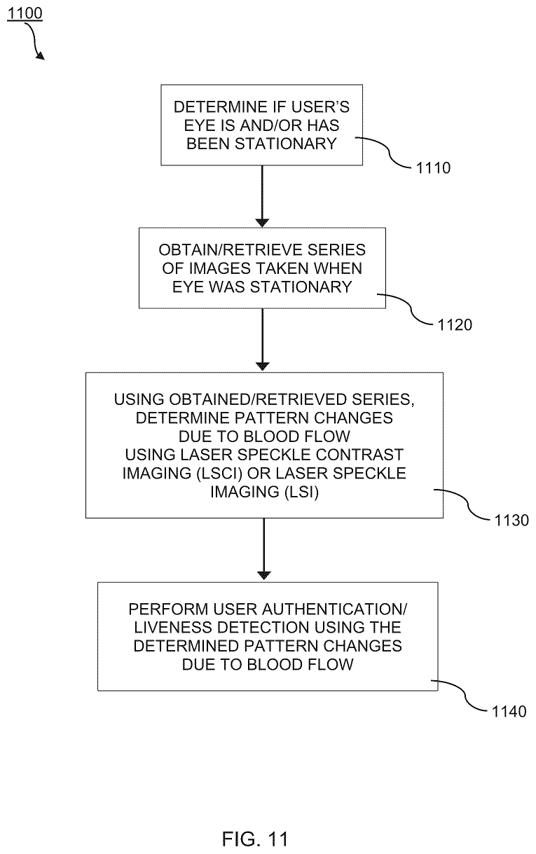

FIG. 11 illustrates a flow diagram for a user authentication and/or liveness detection method using a near-eye display device, according to some examples. The method 1100 shown in FIG. 11 is provided by way of example and may only be one part of the entire user authentication/liveness detection process. The method 1100 may further omit parts of the user authentication/liveness detection process not germane to the present disclosure, as would be understood by one of ordinary skill in the art. Each block shown in FIG. 11 may further represent one or more steps, processes, methods, or subroutines, as would be understood by one of ordinary skill in the art. For the sake of convenience and ease of explanation, the blocks in FIG. 11 may refer to the components of the near-eye display device 700 shown in FIG. 7, although the method 1100 is not limited in any way to the components and/or construction of the near-eye display devices in any of FIG. 3, 7, 8A-8B, 9A-9B, or 10.

At block 1110, the controller 715 may determine if the user's eye is and/or has been stationary (still, motionless, not currently moving). In some examples, an eye tracking system of the near-eye display device may be employed to determine whether the user's eye is presently stationary. In other examples, a controller separate from the eye tracking system may determine the user's eye has been stationary. In some examples, the length of time the eye must be stationary may vary according to the specific components and parameters of the near-eye display device being employed. In some examples, the length of time may depend on how many images the camera(s) 720 may take in a series in a certain amount of time. For instance, if the camera(s) 720 may take a few dozen images in less than a second while the eye is stationary, this may be adequate to perform the following steps in the method 1100. As mentioned herein, 10 to 100 milliseconds of stationary state of the pupil may be sufficient in some cases. In other cases, a small amount (e.g., a few degrees) of motion of the eyeball may be correctible by computer vision algorithms. Thus, such small movements may also be considered as stationary state.

In block 1120, the controller 715 may obtain and/or retrieve a series of images that were taken while the eye was stationary. In some examples such as when the eye tracking system is being employed, this may be done in real-time, i.e., as soon as the controller determines the eye has been stationary for the appropriate period of time, the controller 715 may obtain the images which were already being taken by the eye tracking camera(s) 720 to perform the following steps. In some examples, a controller separate from the eye tracking system may, after determining the user's eye has been stationary for the appropriate period of time, retrieve the series of images from whatever image sensor may be taking images of the user's eye suitable for performing user authentication/liveness detection in accordance with examples of the present disclosure (or whatever storage unit is storing same).

At block 1130, the controller 715 may use the series of images obtained in block 1120 to determine pattern changes due to blood flow in the user's eye and/or surrounding tissue. In some examples, laser speckle contrast imaging (LSCI) or laser speckle imaging (LSI) may be employed to detect the motion of the blood flowing within the capillaries of the eye and/or surrounding tissue. In such examples, speckle statistics may be employed to determine, for example, where the surface capillaries are (by detecting the motion of the blood flowing within), thereby creating a map of the surface capillaries, and/or blood flow dynamics (hemodynamics) of the blood following in the capillaries. In some examples, such blood flow dynamics (hemodynamics) may include, for example, changes in blood flow within the capillaries; the viscosity of the blood plasma; the shapes and dynamics of the red blood cells; the osmotic pressure within the capillaries; hemodilution; the turbulence and velocity of blood flow; vascular resistance, stress, capacitance, and/or wall tension; and/or any other measurement/calculation which may be employed for at least one of user authentication or liveness detection.

At block 1140, the controller 715 may perform user authentication and/or liveness detection using the determined pattern changes due to blood flow in the user's eye and/or surrounding tissue. In some examples, a calculated map of surface capillaries may be employed to authenticate the identity of the user, as the pattern of capillaries in the eye are unique to the individual. Similarly, the mere fact a map of capillaries may be determined proves the user is a live person because of the blood flowing through the capillaries. In some examples, other calculated/determined blood flow dynamics (hemodynamics) of the user's eye and/or surrounding tissue may be employed to authenticate the identity of the user and/or as proof of life.

As mentioned above, one or more processors may be employed in any near-eye display device to perform any of the methods, functions, and/or processes described herein by executing instructions contained on a non-transitory computer-readable storage medium. These one or more processors (such as, e.g., the eye tracking unit 130 or the eye tracking module 118 in console 110 of FIG. 1, the controller 315 of FIG. 3, the controller 430A/B or processors 433A/B in FIG. 4A-4B, the controller 550 or processor 553 in FIG. 5, the controllers 630A, 630B and/or 630D or processors 633A, 633B and/or 633D in FIG. 6A, 6B, an/or 6D, any of the controller(s) 715, 815, 816, 930, 931, and/or 1040 in FIGS. 7A, 8A, 8B, 9A, 9B, and/or 10, respectively, and/or any other processing or controlling module which may be used in the near-eye display device in accordance with the present disclosure as would be understood by one of ordinary skill in the art), may be, or may include, one or more programmable general-purpose or special-purpose single—and/or multi-chip processors, a single—and/or multi-core processors, microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices. Similarly, the non-transitory computer-readable storage medium which may contain those instructions for execution (such as, e.g., the application store 112 in console 110 of FIG. 1, the memories 435A/B in FIG. 4A-4B, the memory 555 in FIG. 5, the memories 635A, 635B and/or 635D in FIG. 6A, 6B, and/or 6D, any non-transitory computer-readable storage medium which may store instructions for the controller(s) 315, 715, 815, 816, 930, 931, and/or 1040 in FIGS. 3, 7A, 8A, 8B, 9A, 9B, and/or 10, respectively, and/or any other storage module which may be used in the near-eye display device in accordance with the present disclosure as would be understood by one of ordinary skill in the art) may include read-only memory (ROM), flash memory, and/or random access memory (RAM)—any of which may be the main memory into which an operating system, various application programs, and/or a Basic Input-Output system (BIOS) which controls basic hardware operation such as the interaction with one or more peripheral components may be loaded/stored. Code or computer-readable instructions to implement the methods, functions, and/or operations discussed and/or described herein may be stored in any suitable computer-readable storage media and/or may be received via one or more communication/transmission interfaces, as would be understood by one of ordinary skill in the art.

According to examples, a method of eye tracking with varying spatial and polarization profiles is described herein. A system of eye tracking is also described herein. A non-transitory computer-readable storage medium may have an executable stored thereon, which when executed instructs a processor to perform the methods described herein.

According to examples, a near-eye display device capable of user authentication and/or liveness detection is described herein. A method of user authentication and/or liveness detection is also described herein. A non-transitory computer-readable storage medium may have an executable stored thereon, which when executed instructs a processor to perform the methods described herein.

As would be understood by one of ordinary skill in the art, generally speaking, any one or more of the components and/or functionalities described in reference to any of the Figures herein may be implemented by hardware, software, and/or any combination thereof, according to examples of the present disclosure. In some examples, the components and/or functionalities may be implemented by at least one of any type of application, program, library, script, task, service, process, or any type or form of executable instructions stored in a non-transitory computer-readable storage medium executed on hardware such as circuitry that may include digital and/or analog elements (e.g., one or more transistors, logic gates, registers, memory devices, resistive elements, conductive elements, capacitive elements, and/or the like, as would be understood by one of ordinary skill in the art). In some examples, the hardware and data processing components used to implement the various processes, operations, logic, and circuitry described in connection with the examples described herein may be implemented with one or more of a general purpose single—and/or multi-chip processor, a single—and/or multi-core processor, a digital signal processor (DSP), an application specific integrated circuit (ASIC), a field programmable gate array (FPGA), or other programmable logic device, discrete gate or transistor logic, discrete hardware components, and/or any combination thereof suitable to perform the functions described herein. A general purpose processor may be any conventional processor, microprocessor, controller, microcontroller, and/or state machine. In some examples, the memory/storage may include one or more components (e.g., random access memory (RAM), read-only memory (ROM), flash or solid state memory, hard disk storage, etc.) for storing data and/or computer-executable instructions for completing and/or facilitating the processing and storage functions described herein. In some examples, the memory/storage may be volatile and/or non-volatile memory, and may include database components, object code components, script components, or any other type of information structure suitable for implementing the various activities and storage functions described herein.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

1. An eye tracking system for a near-eye display device which displays at least one of augmented reality (AR) or virtual reality (VR) content, comprising:
a plurality of vertical-cavity surface-emitting lasers (VCSELs) to project a structured light, comprising:
a first grouping of VCSELs to project structured light of a first polarization state; and
a second grouping of VCSELs to project structured light of a second polarization state; and
an optical assembly comprising one or more optical elements to receive the structured light from the plurality of VCSELs and project the structured light onto an eye,
wherein the structured light projected onto the eye is provided with one or more of a spatially varying intensity profile or a spatially varying polarization profile by a combination of the optical assembly and the first and second grouping of VCSELS in the plurality of VCSELs.

2. The eye tracking system of claim 1, wherein the plurality of VCSELs comprises an array of a plurality of columns and one or more rows, where the first grouping of VCSELs comprises a first column and the second grouping of VCSELs comprises a second column.

3. The eye tracking system of claim 1, wherein the plurality of VCSELs comprises a plurality of groupings of VCSELs, including the first and second groupings of VCSELS, and the groupings of VCSELs are switched on in a temporal sequence.

4. The eye tracking system of claim 1, wherein the optical assembly comprises a Pancharatnam-Berry phase (PBP) element to provide polarization modulation of the structured light projected onto the eye.

5. The eye tracking system of claim 4, wherein the optical assembly comprises a diffractive optical element (DOE) to provide intensity modulation of the structured light projected onto the eye.

6. The eye tracking system of claim 1, further comprising:
a switch disposed between the plurality of VCSELs and the optical assembly, wherein the switch switches between coherent and incoherent illumination for the structured light projected onto the eye; and
an image capture device to capture a reflection of the structured light from the eye,
wherein, when switching is being performed, an image obtained by the image capture device comprises speckled pattern portions which may identify blood vessels of the eye and speckle-free portions which may identify borders of the blood vessels.

7. An eye tracking system for a near-eye display device which displays at least one of augmented reality (AR) or virtual reality (VR) content, comprising:
a plurality of vertical-cavity surface-emitting lasers (VCSELs) to project a structured light, comprising a first grouping of VCSELs and a second grouping of VCSELs;
a controller to control a polarization state of each of the first grouping of VCSELs and the second grouping of VCSELs; and
an optical assembly to receive the structured light from the plurality of VCSELs and project the structured light onto an eye, comprising:
a Pancharatnam-Berry phase (PBP) element to provide polarization modulation of the structured light projected onto the eye; and
a diffractive optical element (DOE) to provide intensity modulation of the structured light projected onto the eye,
wherein the structured light projected onto the eye is provided with one or more of a spatially varying intensity profile or a spatially varying polarization profile by a combination of the optical assembly and the controller separately controlling the first and second grouping of VCSELS in the plurality of VCSELs to provide structured light with light of different polarization states.

8. The eye tracking system of claim 7, further comprising:
a switch disposed between the plurality of VCSELs and the optical assembly, wherein the switch switches between coherent and incoherent illumination for the structured light projected onto the eye; and
an image capture device to capture a reflection of the structured light from the eye,
wherein, when switching is being performed, an image obtained by the image capture device comprises speckled pattern portions which may identify blood vessels of the eye and speckle-free portions which may identify borders of the blood vessels.

9. An eye tracking system for a near-eye display device, comprising:
a light source to illuminate an eye;
an image sensor to capture a series of images of the eye by capturing reflections of the eye illuminated by the light source when the eye is stationary; and
a controller communicatively coupled to the image sensor, the controller to determine reflected pattern changes due to blood flow using the captured series of images of reflections of the eye when the eye is stationary and to perform at least one of user authentication or liveness detection based on the detected pattern changes due to blood flow.

10. The eye tracking system of claim 9, wherein the blood flow is in at least one capillary of the eye or the skin tissue surrounding the eye.

11. The eye tracking system of claim 9, wherein the light source is to illuminate the eye with at least one of a statistically random pattern, an interference pattern, a sinusoidal pattern, a binary pattern, a multi-level pattern, a code-based pattern, a color-based pattern, or a geometrical pattern.

12. The eye tracking system of claim 9, wherein
the light source is to illuminate the eye with a speckle pattern,
the captured series of images comprise a plurality of reflections of the speckle pattern from the eye when the eye is stationary; and
the controller is further to:
compute speckle contrast based on the captured plurality of reflections of the speckle pattern from the eye when the eye is stationary; and
determine the reflected pattern changes due to blood flow based on the computed speckle contrast.

13. The eye tracking system of claim 9, wherein
the light source comprises:
a first light source to illuminate the eye with a first central wavelength; and
a second light source to illuminate the eye with a second central wavelength;
the image sensor is to capture the series of images of the eye when the eye is stationary by capturing at least one reflection of the first central wavelength from the eye when the eye is stationary and at least one reflection of the second central wavelength from the eye when the eye is stationary, and
the controller is further to perform at least one of user authentication and liveness detection based on the captured at least one reflection of the first central wavelength and the captured at least one reflection of the second central wavelength.

14. The eye tracking system of claim 13, wherein the controller is further to:
compute ratiometric data based on the captured at least one reflection of the first central wavelength and the captured at least one reflection of the second central wavelength; and
perform at least one of user authentication and liveness detection based on the computed ratiometric data.

15. The eye tracking system of claim 14, wherein the computed ratiometric data comprises data of a ratio of oxygenated hemoglobin to non-oxygenated hemoglobin.

16. The eye tracking system of claim 9, further comprising:
a waveguide to display at least one of augmented reality (AR) or virtual reality (VR) images to the eye, wherein the light source is integrated with the waveguide.

17. The eye tracking system of claim 9, further comprising:
a retinal projection system to project light into the eye, wherein the controller is further to:
receive image data of a reflection of the light projected by the retinal projection system;
determine a retinal vasculature pattern of the eye based on the received image data; and
perform at least one of user authentication or liveness detection using the determined retinal vasculature pattern of the eye.

18. The eye tracking system of claim 17, wherein the light projected by the retinal projection system is in the near infrared range.

19. The eye tracking system of claim 9, wherein the controller is further to determine when the eye is stationary and to obtain the captured series of images of the eye when the eye is determined to be stationary.

20. The eye tracking system of claim 19, wherein
upon determining the eye is stationary, the controller is further to:
control the light source to illuminate the eye;
control the image sensor to capture the series of images of the eye while the eye is illuminated and stationary; and
determine the reflected pattern changes due to blood flow using the captured series of images of the eye when illuminated and stationary.
